(19) United States
(12) Patent Application Publication
(10) Pub. No.: US 2023/0123323 A1
(43) Pub. Date: Apr. 20, 2023

(54) Familiarity Based Route Generation

(71) Applicants: Matthew SHARIFI, Zürich (CH); Victor CARBUNE, Zürich (CH); Google LLC, Mountain View, CA (US)

(72) Inventors: Matthew Sharifi, Kilchberg (CH); Victor Carbune, Winterthur (CH)

(21) Appl. No.: 16/972,448

(22) PCT Filed: Jul. 6, 2020
(86) PCT No.: PCT/US2020/040892

§ 371 Date: Dec. 4, 2020

(51) Int. Cl. G01C 21/34

(52) U.S. Cl. CPC G01C 21/3484

(57) ABSTRACT

Methods, systems, devices, and tangible non-transitory computer readable media for route familiarity determination and route generation are provided. The disclosed technology can include accessing route data. The route data can include information associated with a starting location and a destination. Routes from the starting location to the destination can be determined based at least in part on the route data. Amounts of familiarity with one or more historical routes that were previously traveled by a user can be determined based on historical route data. Similarities between the one or more routes and the one or more historical routes can be determined based on the historical route data. Suggested routes can be determined based on the routes that satisfy one or more criteria associated with the amounts of familiarity and the similarities. Output including indications associated with the user traveling the one or more suggested routes can be generated.

### FIELD

The present disclosure relates generally to the generation of routes for navigation. More particularly, the present disclosure relates to generating routes based on a determination of user familiarity with potential routes.

### BACKGROUND

Operations associated with the state of a geographic area can be implemented on a variety of computing devices. These operations can include processing data associated with the geographic area for later access and use by a user or computing system. Further, the operations can include exchanging data with remote computing systems. However, the types of operations that are performed and the way in which the operations are performed can vary over time, as can the underlying hardware that implements the operations. It is often the case that processing and/or exchanging data associated with the geographic area can be repeated for the same geographic area or route at each new user request, thereby causing unnecessary processing and/or transmission of data. Accordingly, there are different ways to leverage computing resources associated with the state of a geographic area.

### SUMMARY

Aspects and advantages of embodiments of the present disclosure will be set forth in part in the following description, or can be learned from the description, or can be learned through practice of the embodiments.

One example aspect of the present disclosure is directed to a computer-implemented method of navigation. The computer-implemented method can include accessing, by a computing system including one or more processors, route data including information associated with a starting location and a destination. The computer-implemented method can include determining, by the computing system, based at least in part on the route data, one or more routes from the starting location to the destination. The computer-implemented method can include determining, by the computing system, based at least in part on historical route data, one or more amounts of familiarity with one or more historical routes that were previously traveled by a user. The computer-implemented method can include determining, by the computing system, one or more similarities between the one or more routes and the one or more historical routes. The computer-implemented method can include determining, by the computing system, one or more suggested routes based at least in part on the one or more routes that satisfy one or more criteria associated with the one or more amounts of familiarity and the one or more similarities. Furthermore, the computer-implemented method can include generating, by the computing system, output including one or more indications associated with the user traveling the one or more suggested routes. Additionally, the computer-implemented method can include receiving an input from a user. The input can include a user selected route that is selected from the one or more suggested routes. The computer-implemented method can further include generating navigation directions from the starting location to the destination along the user selected route. The computer-implemented method can further include controlling operation of a vehicle based at least in part on the generated navigation directions. Operation of the vehicle can include navigating the vehicle from the starting location to the destination along the user selected route according to the navigation directions that were generated.

Another example aspect of the present disclosure is directed to one or more tangible non-transitory computer-readable media storing computer-readable instructions that when executed by one or more processors cause the one or more processors to perform operations. The operations can include accessing route data including information associated with a starting location and a destination. The operations can include determining, based at least in part on the route data, one or more routes from the starting location to the destination. The operations can also include determining, based at least in part on historical route data, one or more amounts of familiarity with one or more historical routes that were previously traveled by a user. The operations can include determining one or more similarities between the one or more routes and the one or more historical routes. The operations can include determining one or more suggested routes based at least in part on the one or more routes that satisfy one or more criteria associated with the one or more amounts of familiarity and the one or more similarities. Furthermore, the operations can include generating output including one or more indications associated with the user traveling the one or more suggested routes. Additionally, the operations can include receiving an input from a user. The input can include a user selected route that is selected from the one or more suggested routes. The operations can further include generating navigation directions from the starting location to the destination along the user selected route. The operations can further include controlling operation of a vehicle based at least in part on the generated navigation directions. Operation of the vehicle can include navigating the vehicle from the starting location to the destination along the user selected route according to the navigation directions that were generated.

Another example aspect of the present disclosure is directed to a computing system comprising: one or more processors; one or more non-transitory computer-readable media storing instructions that when executed by the one or more processors cause the one or more processors to perform operations. The operations can include accessing route data including information associated with a starting location and a destination. The operations can include determining, based at least in part on the route data, one or more routes from the starting location to the destination. The operations can also include determining, based at least in part on historical route data, one or more amounts of familiarity with one or more historical routes that were previously traveled by a user. The operations can include determining one or more similarities between the one or more routes and the one or more historical routes. The operations can include determining one or more suggested routes based at least in part on the one or more routes that satisfy one or more criteria associated with the one or more amounts of familiarity and the one or more similarities. Furthermore, the operations can include generating output including one or more indications associated with the user traveling the one or more suggested routes. Additionally, the operations can include receiving an input from a user. The input can include a user selected route that is selected from the one or more suggested routes. The operations can further include generating navigation directions from the starting location to the destination along the user selected route. The operations can further include controlling operation of a vehicle based at least in part on the generated navigation directions. Operation of the vehicle can include navigating the vehicle from the starting location to the destination along the user selected route according to the navigation directions that were generated.

Other aspects of the present disclosure are directed to various systems, apparatuses, non-transitory computer-readable media, user interfaces, and electronic devices.

These and other features, aspects, and advantages of various embodiments of the present disclosure will become better understood with reference to the following description and appended claims. The accompanying drawings, which are incorporated in and constitute a part of this specification, illustrate example embodiments of the present disclosure and, together with the description, serve to explain the related principles.

### BRIEF DESCRIPTION OF THE DRAWINGS

Detailed discussion of embodiments directed to one of ordinary skill in the art is set forth in the specification, which makes reference to the appended figures, in which:

FIG. 1A depicts a block diagram of an example computing system that performs operations associated with the familiarity based generation of routes according to example embodiments of the present disclosure.

FIG. 1B depicts a block diagram of an example computing device that performs operations associated with the familiarity based generation of routes according to example embodiments of the present disclosure.

FIG. 1C depicts a block diagram of an example computing device that performs operations associated with familiarity based generation of routes according to example embodiments of the present disclosure.

FIG. 2 depicts a block diagram of an example of one or more machine-learned models according to example embodiments of the present disclosure.

FIG. 3 depicts an example of a user computing device according to example embodiments of the present disclosure.

FIG. 4 depicts an example of a route generation system according to example embodiments of the present disclosure.

FIG. 5 depicts an example of a route generation system according to example embodiments of the present disclosure.

FIG. 6 depicts an example of a route generation system according to example embodiments of the present disclosure.

FIG. 7 depicts an example of a route generation system according to example embodiments of the present disclosure.

FIG. 8 depicts an example of a route generation system according to example embodiments of the present disclosure.

FIG. 9 depicts an example of a route generation system according to example embodiments of the present disclosure.

FIG. 10 depicts a flow diagram of the generation of suggested routes according to example embodiments of the present disclosure.

FIG. 11 depicts a flow diagram of the generation of suggested routes according to example embodiments of the present disclosure.

FIG. 12 depicts a flow diagram of the generation of suggested routes according to example embodiments of the present disclosure.

FIG. 13 depicts a flow diagram of the generation of suggested routes according to example embodiments of the present disclosure.

FIG. 14 depicts a flow diagram of the generation of suggested routes according to example embodiments of the present disclosure.

FIG. 15 depicts a flow diagram of the generation of suggested routes according to example embodiments of the present disclosure.

FIG. 16 depicts a flow diagram of the generation of suggested routes according to example embodiments of the present disclosure.

Reference numerals that are repeated across plural figures are intended to identify the same features in various implementations.

### DETAILED DESCRIPTION

Example aspects of the present disclosure are directed to a computing system that can be used to suggest travel routes to a user partly on the basis of a set of criteria associated with the user's familiarity with the travel routes between a set of locations. In particular, the disclosed technology can be used to generate suggested travel routes to a user selected destination based on a user's familiarity with previously traveled routes and the similarity of a suggested route to a previously traveled route. Further, the disclosed technology can provide a user with helpful indications including whether a suggested route is likely to be familiar to the user and the similarity of a suggested route to a previously traveled route.

For example, a suggested route can be provided to the driver of a vehicle based on the user having previously traveled certain portions of the route in the past. Further, the suggested routes can be based in part on a user's familiarity with types of routes that share features other than common locations. For example, a user that travels extensively on highways may be determined to be more familiar with new routes that traverse other highways that the user had not previously traveled. As such, the disclosed technology can improve the user's sense of comfort and safety by providing the user with suggested routes that are more likely to be familiar to the user. Further, the user's familiarity with a route allows the user to travel efficiently, without the excessive expenditure of time or energy that may result from navigation of an unfamiliar route.

The disclosed technology can be implemented in a computing system (e.g., a navigation computing system) that is configured to access data, perform operations on the data (e.g., determine suggested routes), and generate output including the suggested travel routes. Further, the computing system can leverage one or more machine-learned models that have been configured to generate output including suggested routes that are more likely to be familiar to a user. The computing system can be included in a vehicle (e.g., an in-vehicle navigation system) or as part of a system that includes a server that receives data associated with a starting location (e.g., a user's current location) and a destination from a client device (e.g., a smart phone), performs operations based on the data and sends output including suggested routes back to the client device, which can be configured to display the suggested routes to a user and receive user feedback regarding the user's familiarity with the suggested routes.

By way of example, the disclosed technology can use the current location of a user (e.g., a user associated with a navigation device which can include a smartphone or an in-vehicle navigation system) to determine a set of routes to a destination requested by a user. Further, the set of routes may be constrained by distance and/or the time required to travel the set of routes. For example, when the shortest route to a destination is twenty (20) kilometers the set of routes may be constrained to a distance of no more than fifty percent (50%) longer than the shortest route (e.g., thirty (30) kilometers). In this way, excessively long but familiar routes may be eliminated from the outset.

A user's amount of familiarity with the set of routes can then be determined on the basis of the user's familiarity with previously traveled routes and the similarity of the set of routes to the previously traveled routes. For example, certain routes may be more familiar to a user based on the frequency of the user previously traveling similar routes, the recency of the user traveling similar routes, and the similarity of features of a current route to features of previously traveled routes. For example, a user that is a long-haul trucker may be more familiar with routes involving extensive highway travel. Further, the set of routes that are familiar can be compared to the previously traveled routes to determine the similarity between the set of routes and the previously traveled routes. Suggested routes can then be determined on the basis of the set of routes that satisfy a set of criteria associated with the familiarity and similarity of the set of routes. For example, the suggested routes may include the set of routes that include the greatest portion of the total travel distance that is the same as the previously traveled routes or that include the greatest portion of the total travel distance that is of the same type (e.g., highway travel) that is the same as the previously traveled routes.

An output can then be generated (e.g., displayed on a user interface presented to the user) and the user can select one of the suggested routes. The output can include indications that let a user know how familiar a suggested route is likely to be or whether a suggested route is similar to a route that was previously traveled by the user. For example, a suggested route may be described as “SIMILAR TO YOUR COMMUTE FROM HOME TO YOUR OFFICE” or “THE KIND OF ROUTE THAT YOU HAVE TRAVELED IN THE PAST.” Furthermore, the computing system can receive user feedback including the suggested routes that were selected by the user. The user selected routes can be included as part of historical route data that can be adjusted on the basis of the user's selections. As such, the disclosed technology can provide more effective suggested routes based on a determination of the likely familiarity of those routes to a user.

Accordingly, the disclosed technology can improve the user experience by providing the user with suggested routes that can be constrained based on the determined familiarity of the routes to the user. Further, the disclosed technology can assist a user in more effectively performing the technical task of using suggested routes as a way to facilitate navigation from one location to another by means of a continued and/or guided human-machine interaction process.

The computing system can access data which can include route data. The route data can include information associated with a starting location and/or a destination. For example, the route data can include a latitude, longitude, and/or altitude associated with one or more locations including the starting location and/or the destination. Further, the route data can include information associated with one or more maps of a geographic area that includes the starting location and/or the destination. For example, the route data can include a map of a city that includes one or more locations of one or more roads (e.g., streets, highways, cycle paths, and/or foot paths), bodies of water (e.g., lakes, rivers, and/or ponds), waterways (e.g., canals), buildings (e.g., office buildings, residential buildings, and/or houses), bridges, tunnels, overpasses, and/or underpasses. Further, the route data can include information associated with traffic regulations (e.g., speed limits in a region) and/or traffic flow patterns (e.g., the direction and/or amount of pedestrian and/or vehicular traffic in a geographic area).

The computing system can determine one or more routes from a starting location (e.g., the current location of a user) to a destination (e.g., a location selected by the user to which the user would like to travel). The one or more routes from the starting location to the destination can be determined based at least in part on the route data. For example, one or more routes between the starting location and the destination can be determined by accessing the route data and determining one or more roads that connect the starting location and the destination.

In some embodiments, the one or more routes that are determined can include the one or more routes that satisfy one or more travel criteria. The one or more travel criteria can include one or more distance constraints and/or one or more time constraints. The one or more distance constraints can include a threshold distance (e.g., a maximum distance) associated with the one or more routes. The maximum distance can be based at least in part on some multiplier of the minimum distance between the starting location and the destination (e.g., a minimum distance along one or more roads or a shortest straight distance between the starting location and the destination). For example, the maximum distance can be one and a half (1.5) times the minimum driving distance between the starting location and the destination. If the driving distance between the starting location and the destination is twenty (20) kilometers, the one or more routes will not include a route that is greater than thirty (30) kilometers long.

Further, the one or more time constraints can include a threshold travel time (e.g., a maximum travel time) for the user to travel each of the one or more routes. For example, the maximum time (travel time) can be one and a half (1.5) times the minimum estimated travel time between the starting location and the destination. If the estimated travel time between the starting location and the destination is thirty (30) minutes, the one or more routes will not include a route with a travel time that is greater than forty-five (45) minutes duration.

The computing system can determine, based at least in part on historical route data, one or more amounts of familiarity with one or more historical routes that were previously traveled by a user. As used herein, the one or more amounts of familiarity can indicate an extent of familiarity, a degree of familiarity, and/or a level of familiarity. Further, the term “one or more amounts of familiarity” can be substituted with and/or used interchangeably with the following terms: “an extent of familiarity” in which an extent of familiarity can be positively correlated with the one or more amounts of familiarity such that a greater extent of familiarity can correspond to a greater amount of familiarity; “one or more degrees of familiarity” in which a greater degree of familiarity can be positively correlated with a greater amount of familiarity such that a greater degree of familiarity can correspond to a greater amount of familiarity; and/or “one or more levels of familiarity” in which a level of familiarity can be positively correlated with the one or more amounts of familiarity such that a greater level of familiarity can correspond to a greater amount of familiarity.

The one or more amounts of familiarity can be positively correlated with the extent to which a user is familiar with the one or more historical routes. The one or more amounts of familiarity can be based at least in part on the user's previous experience with the one or more historical routes including the user's experiences as an active traveler in navigating a historical route (e.g., the driver of a vehicle) and/or as a non-active traveler that traveled the historical route as the passenger of a vehicle (e.g., a train passenger, automobile passenger, or bus passenger).

The historical route data can be strongly encrypted, anonymized (e.g., any personal information associated with the user's identity is either not collected or is deleted after being received), and maintained in a privacy enhancing way (e.g., stored on an encrypted storage component of a local device of the user).

Furthermore, the one or more amounts of familiarity can be positively correlated with a frequency of the user traveling the one or more historical routes and/or a recency of the user traveling the one or more historical routes. For example, a historical route that a user has traveled one-hundred (100) times may be associated with a greater amount of familiarity than a historical route a user has traveled once. Further, a historical route that a user has traveled three (3) times in the past week may be associated with a greater amount of familiarity than a historical route that a user traveled once a year ago.

The historical route data can include information associated with one or more historical routes that were previously traveled by the user including one or more locations that the user previously traveled, one or more identifiers associated with the one or locations (e.g., a street address and/or an informal location identifier such as “the office” or “home”), one or more features of the one or more locations (e.g., features associated with the appearance of a location), and/or a number of times that the user traveled to the one or more locations. In some embodiments, the historical route data can include one or more frequency weights of the one or more historical routes. For example, the one or more historical routes that were more frequently traveled will have a greater frequency weight than the one or more historical routes that were less frequently traveled.

The computing system can determine one or more similarities between the one or more routes and the one or more historical routes. In some embodiments, the computing system can determine an extent or amount of similarity between the one or more routes and the one or more historical routes. The one or more similarities and/or the amount of similarity can be based at least in part on the historical route data. For example, the computing system can access the historical route data and perform one or more comparisons of the one or more routes to the one or more historical routes. The one or more similarities or amount of similarity can be based at least in part on the number of ways or extent to which each of the one or more routes is similar to the one or more historical routes. By way of further example, the amount of similarity can be based at least in part on one or more similarity scores that are determined on the basis of the similarity of one or more features of the one or more routes and the one or more historical routes. Higher similarity scores can be associated with a greater amount of similarity.

Further, the computing system can determine one or more similarities and/or an amount of similarity based on a variety of factors including: the one or more locations that are similar or common to the one or more routes and the one or more historical routes (e.g., a route and a historical route that share the same destination and pass by the same location midway through the route), one or more types of road that are similar or common to the one or more routes and the one or more historical routes (e.g., the user mostly drove on a highway on both a route and a historical route), and/or one or more modes of travel that are similar or common to the one or more routes and the one or more historical routes (e.g., the user rode a bicycle along both a route and a historical route).

The computing system can determine the one or more similarities between the one or more routes and the one or more historical routes based at least in part on one or more machine-learned models. The one or more machine-learned models can be configured and/or trained to determine the one or more similarities between the one or more routes and the one or more historical routes. In some embodiments, the one or more machine-learned models can be used to optimize the historical route data. In particular, the one or more machine-learned models can optimize the historical route data to include the one or more historical routes that are determined to be more likely to be useful in the determination of a user's familiarity with a newly proposed route. For example, the one or more machine-learned models can cluster together the one or more routes that are determined to be more useful in the determination of a user's familiarity with a newly proposed route. Further, various clustering techniques including K-Means clustering can be used.

In some embodiments, the one or more similarities between the one or more routes and the one or more historical routes can be determined based at least in part on providing an input including information and/or data associated with at least one of the one or more routes and at least one of the one or more historical routes. The information and/or data associated with the one or more routes and the one or more historical routes can include one or more images (e.g., a set of geotagged street-level images of the one or more routes and the one or more historical routes) and/or maps of the geographic area (e.g., the geographic area including the starting location and the destination) that can be provided as input to one or more machine-learned models. Further, the information and/or data associated with the one or more routes and the one or more historical routes can include street-related metadata (e.g., locations of traffic signals, locations of traffic signs), traffic behavior at one or more locations, traffic flow along one or more routes, and/or lane width along the one or more routes. The one or more machine-learned models can be configured and/or trained to detect, identify, and/or recognize one or more features depicted in the images and determine one or more similarities between at least one of the one or more routes and at least one of the one or more historic routes. For example, the similarity can be associated with a similarity value that ranges from zero (0) to one (1), with one indicating complete similarity (e.g., the route has the same one or more features as the historic route) and no similarity (e.g., the route does not share any of the one or more features of the historic route).

In some embodiments, determining one or more similarities and/or the amount of similarity between the one or more routes and the one or more historical routes can include determining one or more features of the one or more routes that are similar to one or more features of the one or more historical routes. For example, the computing system can access route data that includes one or more features of the one or more routes. Further, the computing system can access historic route data that includes one or more features of the one or more historic routes. The computing system can then determine which of the one or more features of the one or more routes match and/or are similar to the one or more features of the one or more historic routes. A greater number of matching features and/or similar features between the one or more routes and the one or more historic routes can be positively correlated with a greater number of the one or more similarities and/or amount of similarity.

In some embodiments, the determination of the one or more features that match and/or are similar can be based at least in part on the use of one or more machine-learned models. The one or more machine-learned models can be configured and/or trained to receive input including the one or more routes and the one or more historical routes; perform one or more operations including analyzing the one or more features of the one or more routes and the one or more historical routes; and generate an output including the one or more similarities between the one or more routes and the one or more historical routes.

In some embodiments, the one or more features of the one or more routes that are similar to one or more features of the one or more historical routes can include one or more visual features associated with one or more roads and/or one or more visual features associated with one or more areas that are visible from the one or more roads. For example, the one or more visual features of the one or more historical routes can include one or more road markings (e.g., lane markings, cross walks, and/or parking lines), one or more buildings that are visible from the one or more historic routes, one or more landmarks that are visible from the one or more historic routes, and/or one or more natural features (e.g., mountain ranges, lakes, and/or rivers) that are visible from the one or more historic routes.

The computing system can determine one or more suggested routes. The one or more suggested routes can be based at least in part on the one or more routes that satisfy one or more criteria associated with the one or more amounts of familiarity and the one or more similarities. The one or more criteria can include a threshold amount of familiarity (e.g., the one or more suggested routes exceed a threshold amount of familiarity), a threshold number of the one or more similarities between a route and each of the one or more historical routes, and/or a threshold amount of similarity between a route and each of the one or more historical routes. In some embodiments, the one or more criteria can be based at least in part on one or more user preferences. The one or more user preferences can be determined based at least in part on user input (e.g., the user indicating that a high level of familiarity is weighted more heavily than a low travel time).

The computing system can generate output based at least in part on the one or more suggested routes. The output can include one or more indications associated with the user traveling the one or more suggested routes. For example, the computing system can generate output including a map of the geographic area including the starting location, the destination, and the one or more suggested routes between the starting location and the destination. Further, the output can include a description of any of the one or more suggested routes. For example, the output can include visual and/or auditory descriptions indicating “THIS SUGGESTED ROUTE PASSES BY YOUR OFFICE” and/or “THIS SUGGESTED ROUTE WILL PASS BY POINT PLEASANT PARK” that can be provided via a display device and/or an audio output device (e.g., loudspeakers).

The computing system can determine a ranking of the one or more suggested routes. The ranking can be based at least in part on the one or more similarities between the one or more routes and the one or more historical routes. For example, the one or more routes that are more similar to the one or more historical routes can be more highly ranked than the one or more routes that are less similar to the one or more historical routes.

The computing system can present the one or more suggested routes in an order based at least in part on the ranking. For example, the computing system can generate a visual and/or auditory representation of the one or more suggested routes based on the ranking. A visual representation of the ranking of the one or more suggested routes can include a list including the names and/or addresses associated with the one or more suggested routes with the one or more routes that are similar to the one or more historical routes closer to the top of the list and the one or more suggested routes that are less similar to the one or more historical routes closer to the bottom of the list. In other embodiments, the one or more suggested routes can be arranged in different ways including the most similar suggested route on the left with less similar routes to the right of the most similar suggested route, and/or the most similar suggested route at the bottom with less similar routes on above the most similar suggested route.

Further, the ordering of the one or more suggested routes can be based at least in part on a combination of factors and/or criteria including the respective amounts of familiarity, the respective distances, and/or the respective estimated travel times of the one or more suggested routes. For example, the top ranked suggested route can be the suggested route that is the most familiar, the second ranked suggested route can be the suggested route that is the shortest distance to the destination, and the third ranked suggested route can be the suggested route that has the shortest estimated time to arrive at the destination. For example, the suggested route that is most similar to a historical route can be at the top of the list, the route that is the second most similar to a historical route can be second in the list, and the suggested route that is least similar to a historical route can be at the bottom of the list. By way of further example, an auditory representation of the ranking of the one or more suggested routes can announce the suggested route that is most similar to a historical route first, with subsequent suggested routes announced in an order corresponding to their similarity to the one or more historical routes.

In some embodiments, a predetermined number of the one or more suggested routes with a threshold ranking (e.g., the suggested route with the highest ranking) can be emphasized. Emphasis of the one or more suggested routes that satisfy a threshold ranking can include emphasizing one or more visual properties of an indication associated with the one or more suggested routes that satisfy the threshold ranking. The one or more visual properties can include a particular color (e.g., unique color or a color that is different from the colors used for indications associated with other suggested routes that are not the highest ranked), a particular or distinctive text size, a particular or distinctive shape, and/or a particular or distinctive pattern. For example, the suggested route with the highest ranking can be indicated in a unique color (e.g., the highest ranked route is highlighted in bright green), associated with a different style of font (e.g., bold font or italics for the highest ranked suggested route), and/or presented in a larger size (e.g., a larger font size for the highest ranked suggested route).

The computing system can determine one or more types of road associated with the one or more suggested routes. The determination of the one or more types of road can be based at least in part on the historical route data. For example, the computing system can access the historical route data that includes information associated with one or more types of road that the user previously traveled. Further, the historical route data can include information associated with what amount and/or portion of each of the one or more historical routes comprises the one or more types of road. The one or more types of road can include a highway, an urban road, a suburban road, and/or a rural road.

The computing system can determine, based at least in part on the historical route data, whether the one or more suggested roads include one or more types of road that the user is familiar with. For example, the computing system can access the historical route data that includes information associated with one or more types of road that the user previously traveled. Further, the historical route data can include information associated with what portions and/or amounts of each of the one or more historical routes comprises the one or more types of road. The computing system can then determine whether the user is familiar with the one or more road types based at least in part on the frequency and/or the recency with which the user traveled on the one or more road types. For example, a threshold for familiarity with a road type can be thirty-five percent (35%) of total distance or total time spent on a particular type of road. As such, a user (e.g., a long distance truck driver) that spent ninety-five percent (95%) of their time traveling on highways can be determined to be familiar with highways. In some embodiments, the threshold for familiarity can include an absolute amount of time. For example, the threshold for familiarity can include a threshold number of hours traveled in a time period (e.g., the number of hours traveled in a week, month, or year) and/or a threshold amount of distance traveled in a time period (e.g., a threshold number of kilometers traveled in the past week, month, or year).

The computing system can then generate one or more indications of the one or more suggested routes that use the one or more types of road that are the same as the one or more types of road that the user is familiar with. For example, the computing system can include a notification indicating the type of road (e.g., highway) next to the one or more suggested routes for which the user is familiar with that type of road. As such, the indication of the type of road type may indicate to the user the types of road with which the user is familiar, thereby assisting the user in the process of selecting a suggested route.

The computing system can determine the one or more suggested routes that the user previously traveled. The one or more suggested routes that the user previously traveled can include one or more historical routes that the user traveled as an active traveler (e.g., the passenger of a vehicle) and/or one or more historical routes that the user traveled as a non-active traveler (e.g., a passenger). The computing system can then determine the one or more suggested routes that match a predetermined portion of the one or more historical routes (e.g., a suggested route matches at least half (50%) of a historical route). For example, the historical route data can include information associated with the user's role and/or status during a trip along a route. In particular, the historical route data can include an indication of whether the user was an active traveler and/or a non-active traveler of a historical route.

The computing system can generate one or more indications of the one or more suggested routes that the user previously traveled. For example, the computing system can generate one or more indications including a list of the one or more suggested routes that includes one or more suggested routes that were previously traveled in a first color (e.g., green) and the one or more suggested routes that were not previously traveled routes in a different second color (e.g., red). Further, the computing system can generate one or more indications including a portion of a suggested route that the user previously traveled. For example, the computing system can indicate that “YOU HAVE PREVIOUSLY TRAVELED HALF OF THE SUGGESTED ROUTE” and/or “HALF OF THE SUGGESTED ROUTE IS FAMILIAR TO YOU.” By way of further example, the computing system can generate one or more indications including text stating “YOU TRAVELED THIS ROUTE ON A PREVIOUS OCCASION” in order to notify a user that one or more suggested routes were previously traveled.

In some embodiments, the one or more indications of the one or more suggested routes that the user previously traveled can include one or more images of one or more locations that the user was able to view previously (e.g., view while traveling the one or more historical routes) that are visible from the one or more suggested routes. For example, the one or more images can include an image of a recognizable landmark (e.g., a famous historical building) and/or personally recognizable location (e.g., a user's office building) that is visible from a suggested route.

The computing system can determine one or more suggested routes that include one or more locations that the user has traveled to and/or passed by more than a threshold number of times. For example, the threshold number of times can be three (3) and the one or more suggested routes with one or more locations that the user has traveled to and/or traveled by can be more than three (3) times. Determination of the one or more suggested routes that include one or more locations that the user has traveled to and/or passed by more than a threshold number of times can include a determination of the one or more locations associated with each of the one or more suggested routes that are common to, shared with, or present in one or more portions of the one or more historical routes. The computing system can then compare the one or more locations of a suggested route to each of the one or more historical routes that shares some threshold number of locations (e.g., at least one location in common or three (3) locations in common). The computing system can then determine the one or more suggested routes that include one or more locations that the user has traveled to and/or passed by more than the threshold number of times.

In some embodiments, the threshold number of times can vary based at least in part on the user. For example, the threshold number of times can be greater for a user that tends not to be familiar with a route until the route is traveled many times (e.g., the user is not familiar with a route until the user has traveled the route ten (10) times). Further, the threshold number of times can be lower for a user that tends to become familiar with a route after traveling the route a single time or a small number of times (e.g., the user is familiar with a route after traveling a route twice).

The computing system can then generate one or more indications of the one or more locations that the user has traveled to more than the threshold number of times. For example, the one or more indications can include text stating “YOU HAVE TRAVELED PAST THE SUGGESTED ROUTE THREE TIMES.” By way of further example, the one or more indications can include an audible indication that includes the announcement “YOU HAVE TRAVELED TO SEVERAL LOCATIONS IN THE SUGGESTED ROUTE ON MORE THAN ONE OCCASION.”

The computing system can determine one or more suggested routes that satisfy one or more similarity criteria and/or were traveled by the user in a direction that is different from a direction of travel of the one or more historical routes. Satisfying the one or more similarity criteria can include one or more locations along the one or more suggested routes being within a predetermined distance (e.g., fifteen meters) of one or more locations along the one or more historical routes. Further, the one or more similarity criteria can be satisfied if there are a predetermined number of the one or more locations that are common between the one or more suggested routes and the one or more historical routes.

Furthermore, the computing system can access historical route data that includes one or more indications of the direction of travel along the one or more historical routes. In some embodiments, the direction of travel along the one or more historical routes can be used to determine the one or more amounts of familiarity with the one or more routes. For example, a suggested route that satisfies the one or more similarity criteria and is in the same direction of travel as the direction of travel that a user had used on a historic route can have an associated amount of familiarity that is greater than that of a suggested route that is in the opposite direction of travel as the direction of travel that a user had used on a historic route. For example, a user can be more familiar with a suggested route that returns from the destination to the starting location of a suggested route that was traveled earlier on the same day than a suggested route that returns to the starting location along an arbitrary different route.

Further, the computing system can generate one or more indications of the one or more suggested routes that satisfy the one or more similarity criteria and were traveled by the user in a direction of travel that is different from the direction of travel of the one or more historical routes. For example, the computing system can indicate that the user had previously traveled on a suggested route in a different direction. Further, the computing system can indicate the date and/or time that the user traveled on the suggested route.

The computing system can determine one or more modes of travel associated with the user and/or the one or more suggested routes. The one or more modes of travel can include foot travel, automobile travel, train travel, streetcar travel, bus travel, boat travel, airplane travel, and/or cycling. In some embodiments, the one or more modes of travel can adjust and/or modify the amount of familiarity associated with a route. For example, if a user that is going to use an automobile to travel to a destination had previously traveled a historical route by bicycle, the historical route can have an amount of familiarity to the user that is greater than if the user did not travel the route at all and lower than if the user had traveled the historical route by automobile. Accordingly, the amount of familiarity with a historical route can be associated with the one or more modes of travel that were used to travel the historical route. Further, the amount of familiarity with a historical route can be positively correlated with a similarity between a mode of travel that will be used to travel a route to a destination (e.g., a suggested route to a destination) and the mode of travel used to travel the historical route.

In some embodiments, the one or more modes of travel can be determined based at least in part on user input (e.g., the user providing a mode of travel in response to a request for the user to provide the one or more modes of travel), and/or the vehicle, device, and/or application that the user is currently using (e.g., detecting the vehicle a user is in).

The computing system can generate one or more indications of the one or more suggested routes that use a mode of travel that is the same as the mode of travel associated with the user. For example, the one or more indications can state “YOU CYCLED ON THE SUGGESTED ROUTE LAST WEEK” or “YOU WALKED ON THE SUGGESTED ROUTE A MONTH AGO” to notify the user how and/or when the user had previously traveled a suggested route in the past. Further, the one or more indications of the one or more suggested routes can include an indication of the starting location and/or destination that was used in a historical route that included the same starting location or destination. For example, the one or more indications can state “YOU WALKED TO THE GROCERY STORE ALONG THE SUGGESTED ROUTE.”

In some embodiments, the one or more indications associated with traveling the one or more suggested routes can include one or more portions of the one or more suggested routes that overlap one or more portions of the one or more historical routes. For example, the computing system can generate a map of a region including the starting location and the destination. The map can include one or more indications in which the one or more portions of the one or more suggested routes that overlap one or more portions of the one or more historical routes are highlighted in a different color from the one or more portions of the one or more historical routes that are not overlapped by the one or more suggested routes.

The computing system can generate a prompt requesting feedback comprising an amount of familiarity that the user has with at least one suggested route of the one or more suggested routes. For example, the computing system can generate a prompt on a display device. The prompt can include a request for the user to “PLEASE SELECT THE SUGGESTED ROUTES THAT APPEAR FAMILIAR TO YOU.” The user can then touch a touch screen device to indicate the one or more suggested routes that appear familiar to the user.

In some embodiments, the computing system can determine when the user has arrived at the destination. When the user is determined to have arrived at the destination, a prompt requesting feedback from the user can be generated. The feedback requested from the user can include an amount of familiarity that the user has with the route that was traveled. For example, the computing system can use location data (e.g., location data including the current latitude and longitude of the computing system) and determine that the user has arrived at their destination when the latitude and longitude of the current location matches the latitude and longitude associated with the destination. The computing system can then generate a textual prompt on a display device. The textual prompt can ask the user “WAS THE ROUTE THAT WAS JUST TRAVELED FAMILIAR TO YOU?” or “PLEASE RATE THE FAMILIARITY OF THE ROUTE THAT WAS TRAVELED FROM 1 TO 10 (1 INDICATING THE LOWEST FAMILIARITY AND 10 INDICATING THE GREATEST FAMILIARITY).”

The computing system can adjust the historical route data based at least in part on the feedback. For example, the historical route data can include one or more locations and/or routes that are respectively associated with one or more amounts of familiarity. Feedback indicating that a particular location and/or route is associated with a particular amount of familiarity can be used to adjust the one or more amounts of familiarity associated with the one or more locations and/or the one or more routes. For example, a route that a user had previously traveled that had not been recorded as part of the historical route data may be familiar to the user but may also be indicated in the historical route data as being unfamiliar to the user. Based on the user's feedback, the computing system can adjust the historical route data to indicate that the user is familiar with the route.

In some embodiments, the output can include one or more indications of when each of the one or more suggested routes was recently (e.g., within a predetermined range of recency) or most recently traveled by the user. For example, the output can include a date and/or time at which the user most recently traveled each of the one or more suggested routes. Furthermore, in some embodiments, the output can include one or more indications of whether each of the one or more suggested routes was traveled as an active traveler (e.g., the driver of a vehicle) or as a non-active traveler (e.g., the passenger of a vehicle).

The computing system can receive an input from a user. Further, the input can include a user selected route that is selected from the one or more suggested routes. For example, the computing system can include a touch screen display device that is configured to display one or more textual indications of the one or more suggested routes and receive one or more touch inputs from a passenger to select at least one of the one or more suggested routes as their preferred route to the destination.

The computing system can generate one or more navigation directions and/or navigation instructions from the starting location to the destination along the user selected route. For example, the computing system can use the user selected route to determine the one or more roads and/or user accessible areas (e.g., parking lots, cycle paths, foot paths, and/or paved areas) between the starting location and the destination. The computing system can then determine one or more navigation directions including one or more indications of how the user should follow the user selected route. For example, the one or more navigation directions can include one or more locations to which the user can travel that will allow the user selected path to be followed in a safe manner (e.g., the user will travel the user selected route in a manner that abides with traffic regulations). In some embodiments, the one or more navigation directions can include turn-by-turn instructions that indicate how the user should follow the user selected path including instructions for when a user should turn (e.g., an instruction to turn left at the next intersection).

Further, the one or more navigation directions can include one or more directions and/or one or more instructions that indicate how a vehicle should operate along the user selected route. For example, the one or more navigation directions can indicate a recommended velocity for a vehicle at one or more locations along the user selected route, one or more locations at which the vehicle should accelerate and/or decelerate, one or more locations at which the vehicle should turn, and/or one or more locations at which the vehicle should brake, and/or when the vehicle should signal (e.g., use vehicle signal lights to indicate a vehicle's future actions).

The computing system can control operation of a vehicle based at least in part on the one or more navigation directions and/or the user selected route. Operation of the vehicle can include controlling where the vehicle travels including controlling navigation of the vehicle from the starting location to the destination along the user selected route and/or in accordance with the one or more navigation directions. For example, the computing system can control an autonomous vehicle's computing system that can safely direct the vehicle from the starting location to the destination along the user selected route.

Further, controlling operation of the vehicle can include controlling one or more notification systems that can generate one or more notifications associated with the user selected route. For example, the one or more notifications can include an auditory acknowledgement of receipt of the user selected route (e.g., a synthetic voice or text indicating, “USER SELECTED ROUTE ACKNOWLEDGED. NAVIGATION TO THE DESTINATION WILL COMMENCE SHORTLY.”) and an auditory and/or visual indication associated with traveling to the user selected route (e.g., an estimated time of arrival at the destination and/or a distance remaining to the destination).

The disclosed technology can include a computing system (e.g., a navigation computing system) that is configured to perform various operations associated with the generation of suggested routes. In some embodiments, the computing system can be associated with various computing systems and/or computing devices that use, send, receive, and/or generate suggested routes and/or indications associated with the suggested routes. Furthermore, the computing system can access, generate, process, modify, and/or communicate (e.g., send, and/or receive) data and/or information including data and/or information associated with suggested routes that can include maps of one or more geographic regions through which the suggested routes will pass.

The computing system can include specialized hardware and/or software that enable the performance of one or more operations specific to the disclosed technology. The computing system can include one or more application specific integrated circuits that are configured to perform operations associated with determining a user's familiarity with previously traveled routes, determining the similarity of new routes to the previously traveled routes, determining suggested routes, and generating output that can allow a user to select a suggested route based on the user's familiarity. By way of example, the computing system can be configured to control one or more vehicle systems of a vehicle based at least in part on the user's selection of a suggested route. The one or more vehicle systems can include operational systems that are used to control operation of a vehicle and guide the vehicle to a destination along a suggested route that the user selected.

Additionally, the computing system can be configured to generate data used to implement one or more indications associated with the suggested travel routes. The one or more indications can include one or more visual indications and/or one or more auditory indications associated with the suggested routes. For example, the computing system can generate one or more visual indications including a list of the suggested routes in which the shortest route and the route that is determined to be most familiar to the user are highlighted.

The systems, methods, devices, apparatuses, and tangible non-transitory computer-readable media in the disclosed technology can provide a variety of technical effects and benefits including an improvement in the determination of routes to suggest to a user. In particular, the disclosed technology may assist a user (e.g. a user of a navigation device) in performing technical tasks by means of a continued and/or guided human-machine interaction process in which suggested routes are provided to a user on the basis of the user's familiarity with previously traveled routes and user feedback in response to queries regarding the familiarity of a traveled route. Furthermore, the disclosed technology may also provide additional benefits including better resource usage efficiency, a reduction in environmental impact, and improved safety.

The disclosed technology can improve the efficiency of resource consumption (e.g., reduce energy used in processing by a computing system, reduce bandwidth utilization over a network, reduce fuel and electrical energy consumption by various devices). In particular, by generating output including suggested routes that a user is more likely to be familiar with, portions of historical routes and navigation directions for historical routes are more likely to be included in subsequent routes. As a result, since these portions of historical routes and navigation directions for historical routes have already been computed and/or received before by the computing system, the computational load on the one or more processors of the computing system and/or the amount of data that needs to be received from a server in order to generate subsequent routes are reduced. Therefore, the technology brings about reduced processing and/or bandwidth utilization. Additionally, generating output including suggested routes that a user is more likely to be familiar with, can save the user from energy consuming detours that may result from the user traveling an unfamiliar route. For example, the user traveling a familiar route can result in a reduction in the amount of energy (e.g., fuel and/or electric energy) associated with making course corrections due to user unfamiliarity.

The disclosed technology can also be used to reduce the adverse environmental impact associated with frequent stops and course corrections that may occur when a route is unfamiliar to a user. For example, an amount of user familiarity with a route may be negatively correlated with the amount of vehicle exhaust (and thereby the amount of air pollution) associated with traveling along a travel route. The disclosed technology can thus be used to reduce the amount of pollution that is associated with travel.

Further, the disclosed technology can provide the technical effect of improving the efficiency with which tasks that require a user to follow a route to perform the task. For example, delivery drivers may more efficiently follow navigational instructions that are associated with suggested routes that are more familiar to the driver, which can increase the likelihood that a timely delivery is made and reduce the incidence of down-time in which the driver examines unfamiliar navigational instructions. Further, the computing system associated with generating the suggested routes and navigational instructions can be continuously be updated in response to user feedback and/or learning of patterns and/or types of routes that are familiar and/or more likely to be familiar to a user. For example, one or more machine-learned models can be used to determine routes that include features (e.g., the primary type of road for a route and/or familiar landmarks) that are more familiar to a user. Further, the one or more machine-learned models can be continuously trained and/or updated in response to a user's use of the suggested routes and/or in response to direct feedback from the user.

The disclosed technology can improve the safety of navigating a vehicle by suggesting routes that a user is more familiar with, thereby reducing the user's need to divert their attention from the familiar environment through which the user guides a vehicle. For example, the disclosed technology can suggest a route that includes a location that the user is familiar with (e.g., a restaurant the user regularly patronizes) as a midway point to a destination, followed by more specific instructions for portions of the suggested route that are less familiar to the user. In this way the user can operate a vehicle more safely by focusing more attention on driving the vehicle and less attention on receiving instructions. Therefore, the disclosed technology produces an effect which does not depend on psychological or subjective factors, but on physical and objective parameters based on human physiology.

As such, the disclosed technology may assist the user of a navigation device in more effectively performing a variety of tasks with the specific benefits of reduced resource consumption, reduced environmental impact, and improved safety. Further, any of the specific benefits provided to users can be used to improve the effectiveness of a wide variety of devices and services including route determination devices and/or route determination services that provide navigational routes. Accordingly, the improvements offered by the disclosed technology can result in tangible benefits to a variety of devices and/or systems including mechanical, electronic, and computing systems associated with routing and/or providing routes for use in navigation.

With reference now to the Figures, example embodiments of the present disclosure will be discussed in further detail.

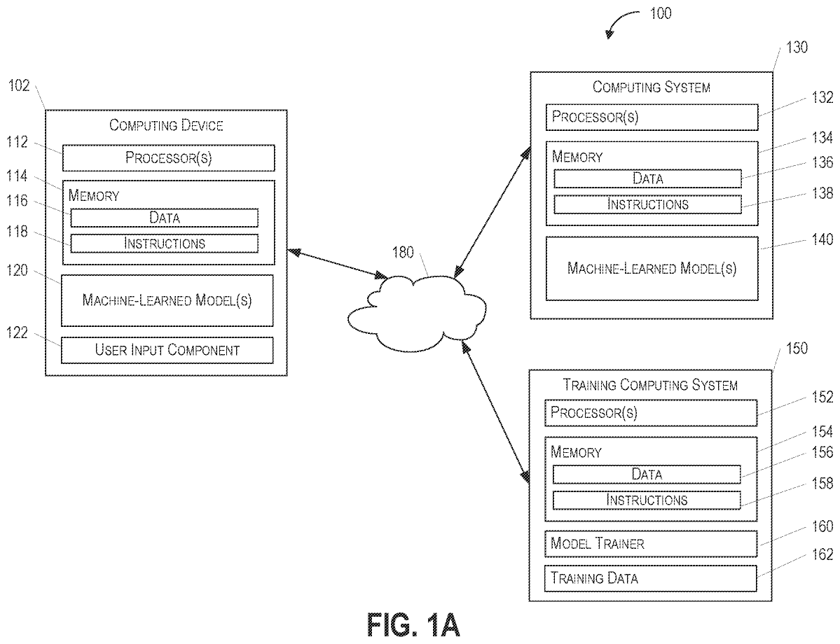

FIG. 1A depicts a block diagram of an example computing system 100 that performs operations associated with the generation of suggested routes according to example embodiments of the present disclosure. The system 100 includes a user computing device 102, a server computing system 130, and a training computing system 150 that are communicatively coupled over a network 180.

The user computing device 102 can be any type of computing device, such as, for example, a personal computing device (e.g., laptop or desktop), a mobile computing device (e.g., smartphone or tablet), a gaming console or controller, a wearable computing device, an embedded computing device, or any other type of computing device.

The user computing device 102 includes one or more processors 112 and a memory 114. The one or more processors 112 can be any suitable processing device (e.g., a processor core, a microprocessor, an ASIC, a FPGA, a controller, a microcontroller, etc.) and can be one processor or a plurality of processors that are operatively connected. The memory 114 can include one or more non-transitory computer-readable storage mediums, such as RAM, ROM, EEPROM, EPROM, flash memory devices, magnetic disks, etc., and combinations thereof. The memory 114 can store data 116 and instructions 118 which are executed by the processor 112 to cause the user computing device 102 to perform operations.

In some implementations, the user computing device 102 can store or include one or more machine-learned models 120. For example, the one or more machine-learned models 120 can be or can otherwise include various machine-learned models such as neural networks (e.g., deep neural networks) or other types of machine-learned models, including non-linear models and/or linear models. Neural networks can include feed-forward neural networks, recurrent neural networks (e.g., long short-term memory recurrent neural networks), convolutional neural networks or other forms of neural networks. Examples of one or more machine-learned models 120 are discussed with reference to FIGS. 1A-16.

In some implementations, the one or more machine-learned models 120 can be received from the server computing system 130 over network 180, stored in the user computing device memory 114, and then used or otherwise implemented by the one or more processors 112. In some implementations, the user computing device 102 can implement multiple parallel instances of a single machine-learned model 120 (e.g., to perform parallel operations to determine and/or generate suggested routes based on user familiarity with the routes).

More particularly, the one or more machine-learned models 120 can be configured and/or trained to access route data and/or historical route data; determine one or more routes; determine one or more amounts of familiarity of historical routes; determine one or more similarities between determined routes (similarities between potential routes and previously traveled routes); and generate suggested routes.

Additionally, or alternatively, one or more machine-learned models 140 can be included in or otherwise stored and implemented by the server computing system 130 that communicates with the user computing device 102 according to a client-server relationship. For example, the one or more machine-learned models 140 can be implemented by the server computing system 140 as a portion of a web service (e.g., a route familiarity service that suggests familiar routes to a user). Thus, one or more models 120 can be stored and implemented at the user computing device 102 and/or one or more models 140 can be stored and implemented at the server computing system 130.

The user computing device 102 can also include one or more of the user input component 122 that is configured to receive user input. For example, the user input component 122 can be a touch-sensitive component (e.g., a touch-sensitive display screen or a touch pad) that is sensitive to the touch of a user input object (e.g., a finger or a stylus). The touch-sensitive component can serve to implement a virtual keyboard. Other example user input components include a microphone, a traditional keyboard, or other means by which a user can provide user input.

The server computing system 130 includes one or more processors 132 and a memory 134. The one or more processors 132 can be any suitable processing device (e.g., a processor core, a microprocessor, an ASIC, a FPGA, a controller, a microcontroller, etc.) and can be one processor or a plurality of processors that are operatively connected. The memory 134 can include one or more non-transitory computer-readable storage mediums, such as RAM, ROM, EEPROM, EPROM, flash memory devices, magnetic disks, etc., and combinations thereof. The memory 134 can store data 136 and instructions 138 which are executed by the processor 132 to cause the server computing system 130 to perform operations.

In some implementations, the server computing system 130 includes or is otherwise implemented by one or more server computing devices. In instances in which the server computing system 130 includes plural server computing devices, such server computing devices can operate according to sequential computing architectures, parallel computing architectures, or some combination thereof.

As described above, the server computing system 130 can store or otherwise include one or more machine-learned models 140. For example, the models 140 can be or can otherwise include various machine-learned models. Example machine-learned models include neural networks or other multi-layer non-linear models. Example neural networks include feed forward neural networks, deep neural networks, recurrent neural networks, and convolutional neural networks. Example models 140 are discussed with reference to FIGS. 1A-15.

The user computing device 102 and/or the server computing system 130 can train the models 120 and/or 140 via interaction with the training computing system 150 that is communicatively coupled over the network 180. The training computing system 150 can be separate from the server computing system 130 or can be a portion of the server computing system 130.

The training computing system 150 includes one or more processors 152 and a memory 154. The one or more processors 152 can be any suitable processing device (e.g., a processor core, a microprocessor, an ASIC, a FPGA, a controller, a microcontroller, etc.) and can be one processor or a plurality of processors that are operatively connected. The memory 154 can include one or more non-transitory computer-readable storage mediums, such as RAM, ROM, EEPROM, EPROM, flash memory devices, magnetic disks, etc., and combinations thereof. The memory 154 can store data 156 and instructions 158 which are executed by the processor 152 to cause the training computing system 150 to perform operations. In some implementations, the training computing system 150 includes or is otherwise implemented by one or more server computing devices.

The training computing system 150 can include a model trainer 160 that trains the machine-learned models 120 and/or 140 stored at the user computing device 102 and/or the server computing system 130 using various training or learning techniques, such as, for example, backwards propagation of errors. For example, a loss function can be backpropagated through the model(s) to update one or more parameters of the model(s) (e.g., based on a gradient of the loss function). Various loss functions can be used such as mean squared error, likelihood loss, cross entropy loss, hinge loss, and/or various other loss functions. Gradient descent techniques can be used to iteratively update the parameters over a number of training iterations.

In some implementations, performing backwards propagation of errors can include performing truncated backpropagation through time. The model trainer 160 can perform a number of generalization techniques (e.g., weight decays, dropouts, etc.) to improve the generalization capability of the models being trained.

In particular, the model trainer 160 can train the one or more machine-learned models 120 and/or the one or more machine-learned models 140 based on a set of training data 162. The training data 162 can include, for example, one or more images of one or more locations, one or more images environments associated with one or more routes, one or more indications of how familiar one or more routes are to a user, and/or historical route data including information associated with previously traveled routes.

In some implementations, if the user has provided consent, the training examples can be provided by the user computing device 102. Thus, in such implementations, the model 120 provided to the user computing device 102 can be trained by the training computing system 150 on user-specific data received from the user computing device 102. In some instances, this process can be referred to as personalizing the model.

The model trainer 160 includes computer logic utilized to provide desired functionality. The model trainer 160 can be implemented in hardware, firmware, and/or software controlling a general purpose processor. For example, in some implementations, the model trainer 160 includes program files stored on a storage device, loaded into a memory and executed by one or more processors. In other implementations, the model trainer 160 includes one or more sets of computer-executable instructions that are stored in a tangible computer-readable storage medium such as RAM hard disk or optical or magnetic media.

The network 180 can be any type of communications network, such as a local area network (e.g., intranet), wide area network (e.g., Internet), or some combination thereof and can include any number of wired or wireless links. In general, communication over the network 180 can be carried via any type of wired and/or wireless connection, using a wide variety of communication protocols (e.g., TCP/IP, HTTP, SMTP, FTP), encodings or formats (e.g., HTML, XML), and/or protection schemes (e.g., VPN, secure HTTP, SSL).

The machine-learned models described in this specification may be used in a variety of tasks, applications, and/or use cases.

In some implementations, the input to the machine-learned model(s) of the present disclosure can include image data. The machine-learned model(s) can process the image data to generate an output. As an example, the machine-learned model(s) can process the image data to generate an image recognition output (e.g., a recognition of the image data, a latent embedding of the image data, an encoded representation of the image data, a hash of the image data, etc.). As another example, the machine-learned model(s) can process the image data to generate an image segmentation output. As another example, the machine-learned model(s) can process the image data to generate an image classification output. As another example, the machine-learned model(s) can process the image data to generate an image data modification output (e.g., an alteration of the image data, etc.). As another example, the machine-learned model(s) can process the image data to generate an encoded image data output (e.g., an encoded and/or compressed representation of the image data, etc.). As another example, the machine-learned model(s) can process the image data to generate an upscaled image data output. As another example, the machine-learned model(s) can process the image data to generate a prediction output.

In some implementations, the input to the machine-learned model(s) of the present disclosure can be text or natural language data. The machine-learned model(s) can process the text or natural language data to generate an output. As an example, the machine-learned model(s) can process the natural language data to generate a language encoding output. As another example, the machine-learned model(s) can process the text or natural language data to generate a latent text embedding output. As another example, the machine-learned model(s) can process the text or natural language data to generate a translation output. As another example, the machine-learned model(s) can process the text or natural language data to generate a classification output. As another example, the machine-learned model(s) can process the text or natural language data to generate a textual segmentation output. As another example, the machine-learned model(s) can process the text or natural language data to generate a semantic intent output. As another example, the machine-learned model(s) can process the text or natural language data to generate an upscaled text or natural language output (e.g., text or natural language data that is higher quality than the input text or natural language, etc.). As another example, the machine-learned model(s) can process the text or natural language data to generate a prediction output.

In some implementations, the input to the machine-learned model(s) of the present disclosure can include speech data. The machine-learned model(s) can process the speech data to generate an output. As an example, the machine-learned model(s) can process the speech data to generate a speech recognition output. As another example, the machine-learned model(s) can process the speech data to generate a speech translation output. As another example, the machine-learned model(s) can process the speech data to generate a latent embedding output. As another example, the machine-learned model(s) can process the speech data to generate an encoded speech output (e.g., an encoded and/or compressed representation of the speech data, etc.). As another example, the machine-learned model(s) can process the speech data to generate an upscaled speech output (e.g., speech data that is of higher quality than the input speech data, etc.). As another example, the machine-learned model(s) can process the speech data to generate a textual representation output (e.g., a textual representation of the input speech data, etc.). As another example, the machine-learned model(s) can process the speech data to generate a prediction output.

In some implementations, the input to the machine-learned model(s) of the present disclosure can be latent encoding data (e.g., a latent space representation of an input, etc.). The machine-learned model(s) can process the latent encoding data to generate an output. As an example, the machine-learned model(s) can process the latent encoding data to generate a recognition output. As another example, the machine-learned model(s) can process the latent encoding data to generate a reconstruction output. As another example, the machine-learned model(s) can process the latent encoding data to generate a search output. As another example, the machine-learned model(s) can process the latent encoding data to generate a reclustering output. As another example, the machine-learned model(s) can process the latent encoding data to generate a prediction output.

In some implementations, the input to the machine-learned model(s) of the present disclosure can be statistical data. The machine-learned model(s) can process the statistical data to generate an output. As an example, the machine-learned model(s) can process the statistical data to generate a recognition output. As another example, the machine-learned model(s) can process the statistical data to generate a prediction output. As another example, the machine-learned model(s) can process the statistical data to generate a classification output. As another example, the machine-learned model(s) can process the statistical data to generate a segmentation output. As another example, the machine-learned model(s) can process the statistical data to generate a segmentation output. As another example, the machine-learned model(s) can process the statistical data to generate a visualization output. As another example, the machine-learned model(s) can process the statistical data to generate a diagnostic output.

In some implementations, the input to the machine-learned model(s) of the present disclosure can be sensor data. The machine-learned model(s) can process the sensor data to generate an output. As an example, the machine-learned model(s) can process the sensor data to generate a recognition output. As another example, the machine-learned model(s) can process the sensor data to generate a prediction output. As another example, the machine-learned model(s) can process the sensor data to generate a classification output. As another example, the machine-learned model(s) can process the sensor data to generate a segmentation output. As another example, the machine-learned model(s) can process the sensor data to generate a segmentation output. As another example, the machine-learned model(s) can process the sensor data to generate a visualization output. As another example, the machine-learned model(s) can process the sensor data to generate a diagnostic output. As another example, the machine-learned model(s) can process the sensor data to generate a detection output.

In some cases, the machine-learned model(s) can be configured to perform a task that includes encoding input data for reliable and/or efficient transmission or storage (and/or corresponding decoding). For example, the task may be an audio compression task. The input may include audio data and the output may comprise compressed audio data. In another example, the input includes visual data (e.g. one or more images or videos), the output comprises compressed visual data, and the task is a visual data compression task. In another example, the task may comprise generating an embedding for input data (e.g. input audio or visual data).

In some cases, the input includes visual data and the task is a computer vision task. In some cases, the input includes pixel data for one or more images and the task is an image processing task. For example, the image processing task can be image classification, where the output is a set of scores, each score corresponding to a different object class and representing the likelihood that the one or more images depict an object belonging to the object class. The image processing task may be object detection, where the image processing output identifies one or more regions in the one or more images and, for each region, a likelihood that region depicts an object of interest. As another example, the image processing task can be image segmentation, where the image processing output defines, for each pixel in the one or more images, a respective likelihood for each category in a predetermined set of categories. For example, the set of categories can be foreground and background. As another example, the set of categories can be object classes. As another example, the image processing task can be depth estimation, where the image processing output defines, for each pixel in the one or more images, a respective depth value. As another example, the image processing task can be motion estimation, where the network input includes multiple images, and the image processing output defines, for each pixel of one of the input images, a motion of the scene depicted at the pixel between the images in the network input.

In some cases, the input includes audio data representing a spoken utterance and the task is a speech recognition task. The output may comprise a text output which is mapped to the spoken utterance. In some cases, the task comprises encrypting or decrypting input data. In some cases, the task comprises a microprocessor performance task, such as branch prediction or memory address translation.

FIG. 1A illustrates one example computing system that can be used to implement the present disclosure. Other computing systems can be used as well. For example, in some implementations, the user computing device 102 can include the model trainer 160 and the training dataset 162. In such implementations, the models 120 can be both trained and used locally at the user computing device 102. In some of such implementations, the user computing device 102 can implement the model trainer 160 to personalize the models 120 based on user-specific data.

FIG. 1B depicts a block diagram of an example computing device 10 that performs according to example embodiments of the present disclosure. The computing device 10 can be a user computing device or a server computing device.

The computing device 10 includes a number of applications (e.g., applications 1 through N). Each application contains its own machine learning library and machine-learned model(s). For example, each application can include a machine-learned model. Example applications include a mapping application, a routing application, a text messaging application, an email application, a dictation application, a virtual keyboard application, a browser application, etc.

As illustrated in FIG. 1B, each application can communicate with a number of other components of the computing device, such as, for example, one or more sensors, a context manager, a device state component, and/or additional components. In some implementations, each application can communicate with each device component using an API (e.g., a public API). In some implementations, the API used by each application is specific to that application.

FIG. 1C depicts a block diagram of an example computing device 50 that performs according to example embodiments of the present disclosure. The computing device 50 can be a user computing device or a server computing device.

The computing device 50 includes a number of applications (e.g., applications 1 through N). Each application is in communication with a central intelligence layer. Example applications include a mapping application, a routing application, a text messaging application, an email application, a dictation application, a virtual keyboard application, a browser application, etc. In some implementations, each application can communicate with the central intelligence layer (and model(s) stored therein) using an API (e.g., a common API across all applications).

The central intelligence layer includes a number of machine-learned models. For example, as illustrated in FIG. 1C, a respective machine-learned model (e.g., a model) can be provided for each application and managed by the central intelligence layer. In other implementations, two or more applications can share a single machine-learned model. For example, in some implementations, the central intelligence layer can provide a single model (e.g., a single model) for all of the applications. In some implementations, the central intelligence layer is included within or otherwise implemented by an operating system of the computing device 50.

The central intelligence layer can communicate with a central device data layer. The central device data layer can be a centralized repository of data for the computing device 50. As illustrated in FIG. 1C, the central device data layer can communicate with a number of other components of the computing device, such as, for example, one or more sensors, a context manager, a device state component, and/or additional components. In some implementations, the central device data layer can communicate with each device component using an API (e.g., a private API).

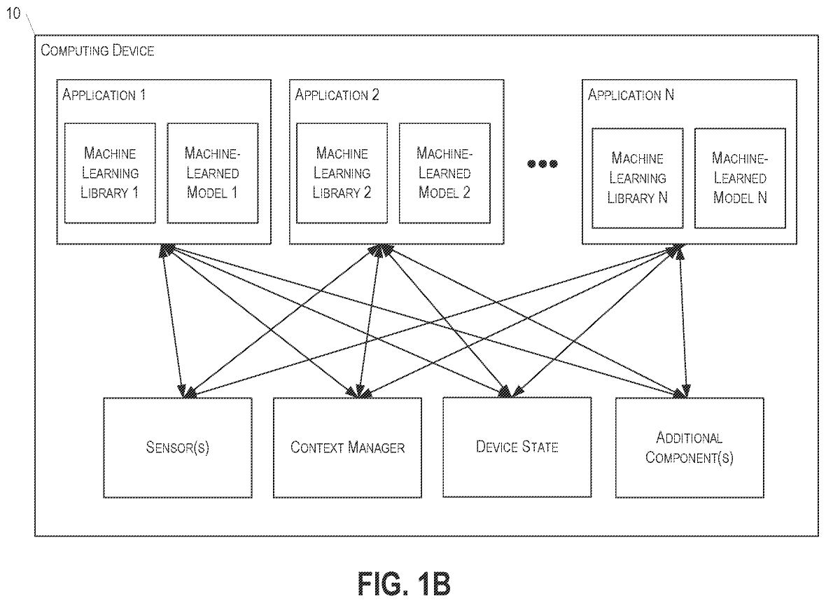

FIG. 2 depicts a block diagram of an example of one or more machine-learned models 200 according to example embodiments of the present disclosure. In some implementations, the one or more machine-learned models 200 are trained to receive a set of input data 204 descriptive of one or more routes (e.g., a potential route and a previously traveled route) and, after performing one or more operations on the input data 204, generating output data 206 that includes information associated with the similarity of the potential route to the previously traveled route and/or a user's familiarity with the potential route. Thus, in some implementations, the one or more machine-learned models 200 can include a route familiarity determination machine-learned model 202 that is operable to generate output associated with one or more routes that are familiar to a user.

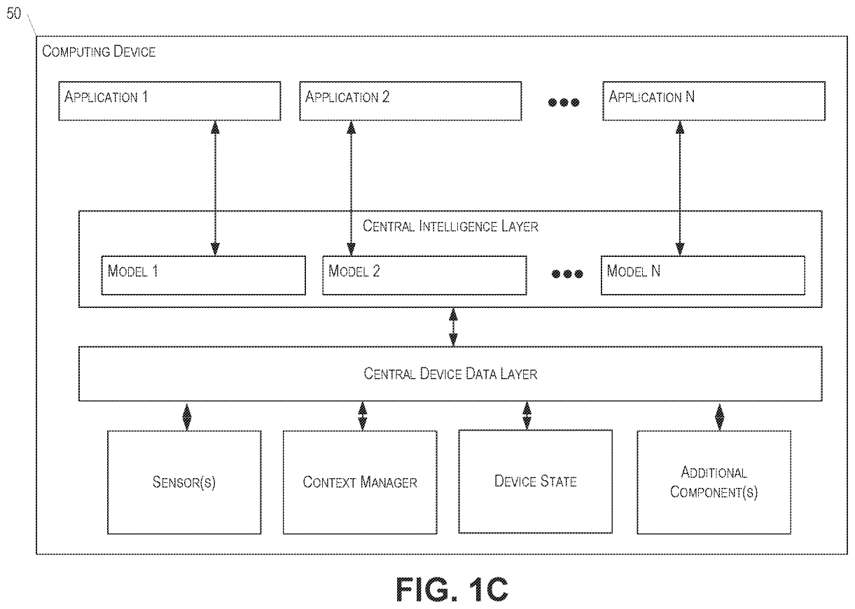

FIG. 3 depicts a diagram of an example computing device according to example embodiments of the present disclosure. A computing device 300 can include one or more attributes and/or capabilities of the computing device 102, the computing system 130, and/or the training computing system 150. Furthermore, the computing device 300 can perform one or more actions and/or operations including the one or more actions and/or operations performed by the computing device 102, the computing system 130, and/or the training computing system 150, which are depicted in FIG. 1A.

As shown in FIG. 3, the computing device 300 can include one or more memory devices 302, route data 304, historical route data 306, one or more machine-learned models 308, one or more interconnects 310, one or more processors 320, a network interface 322, one or more mass storage devices 324, one or more output devices 326, one or more sensors 328, one or more input devices 330, and/or the location device 332.

The one or more memory devices 302 can store information and/or data (e.g., the route data 304, the historical route data 306, and/or the one or more machine-learned models 308). Further, the one or more memory devices 302 can include one or more non-transitory computer-readable storage media, including RAM, ROM, EEPROM, EPROM, flash memory devices, magnetic disks, and combinations thereof. The information and/or data stored by the one or more memory devices 302 can be executed by the one or more processors 320 to cause the computing device 300 to perform operations including operations associated with generating one or more suggested routes that are familiar to a user.

The route data 304 can include one or more portions of data (e.g., the data 116, the data 136, and/or the data 156, which are depicted in FIG. 1A) and/or instructions (e.g., the instructions 118, the instructions 138, and/or the instructions 158 which are depicted in FIG. 1A) that are stored in the memory 114, the memory 134, and/or the memory 154 respectively. Furthermore, the route data 304 can include information associated with one or more routes between a starting location and a destination that can be implemented on the computing device 300. In some embodiments, the route data 304 can be received from one or more computing systems (e.g., the computing system 130 that is depicted in FIG. 1) which can include one or more computing systems that are remote (e.g., in another room, building, part of town, city, or nation) from the computing device 300.

The historical route data 306 can include one or more portions of data (e.g., the data 116, the data 136, and/or the data 156, which are depicted in FIG. 1A) and/or instructions (e.g., the instructions 118, the instructions 138, and/or the instructions 158 which are depicted in FIG. 1A) that are stored in the memory 114, the memory 134, and/or the memory 154 respectively. Furthermore, the historical route data 306 can include information associated with one or more historical routes that were previously traveled by a user and that can be implemented on the computing device 300. In some embodiments, the historical route data 306 can be received from one or more computing systems (e.g., the computing system 130 that is depicted in FIG. 1) which can include one or more computing systems that are remote from the computing device 300.

The one or more machine-learned models 308 (e.g., the one or more machine-learned models 120 and/or the one or more machine-learned models 140) can include one or more portions of the data 116, the data 136, and/or the data 156 which are depicted in FIG. 1A and/or instructions (e.g., the instructions 118, the instructions 138, and/or the instructions 158 which are depicted in FIG. 1A) that are stored in the memory 114, the memory 134, and/or the memory 154 respectively. Furthermore, the one or more machine-learned models 308 can include information associated with access route data and/or historical route data; determine one or more routes; determine one or more amounts of familiarity of historical routes; determine one or more similarities between determined routes (similarities between potential routes and previously traveled routes); and generate suggested routes. In some embodiments, the one or more machine-learned models 308 can be received from one or more computing systems (e.g., the computing system 130 that is depicted in FIG. 1) which can include one or more computing systems that are remote from the computing device 300.

The one or more interconnects 310 can include one or more interconnects or buses that can be used to send and/or receive one or more signals (e.g., electronic signals) and/or data (e.g., the route data 304, the historical data 306, and/or the one or more machine-learned models 308) between components of the computing device 300, including the one or more memory devices 302, the one or more processors 320, the network interface 322, the one or more mass storage devices 324, the one or more output devices 326, the one or more sensors 328 (e.g., a sensor array), and/or the one or more input devices 330. The one or more interconnects 310 can be arranged or configured in different ways including as parallel or serial connections. Further the one or more interconnects 310 can include one or more internal buses to connect the internal components of the computing device 300; and one or more external buses used to connect the internal components of the computing device 300 to one or more external devices. By way of example, the one or more interconnects 310 can include different interfaces including Industry Standard Architecture (ISA), Extended ISA, Peripheral Components Interconnect (PCI), PCI Express, Serial AT Attachment (SATA), HyperTransport (HT), USB (Universal Serial Bus), Thunderbolt, IEEE 1394 interface (FireWire), and/or other interfaces that can be used to connect components.

The one or more processors 320 can include one or more computer processors that are configured to execute the one or more instructions stored in the one or more memory devices 302. For example, the one or more processors 320 can, for example, include one or more general purpose central processing units (CPUs), application specific integrated circuits (ASICs), and/or one or more graphics processing units (GPUs). Further, the one or more processors 320 can perform one or more actions and/or operations including one or more actions and/or operations associated with the route data 304, the historical data 306, and/or the one or more machine-learned models 308. The one or more processors 320 can include single or multiple core devices including a microprocessor, microcontroller, integrated circuit, and/or a logic device.

The network interface 322 can support network communications. For example, the network interface 322 can support communication via networks including a local area network and/or a wide area network (e.g., the Internet). The one or more mass storage devices 324 (e.g., a hard disk drive and/or a solid state drive) can be used to store data including the route data 304, the historical route data 306, and/or the one or more machine-learned models 308. The one or more output devices 326 can include one or more display devices (e.g., LCD display, OLED display, Mini-LED display, microLED display, plasma display, and/or CRT display), one or more light sources (e.g., LEDs), one or more loudspeakers, and/or one or more haptic output devices (e.g., one or more devices that are configured to generate vibratory output).

The one or more input devices 330 can include one or more keyboards, one or more touch sensitive devices (e.g., a touch screen display), one or more buttons (e.g., ON/OFF buttons and/or YES/NO buttons), one or more microphones, and/or one or more cameras.

The one or more memory devices 302 and the one or more mass storage devices 324 are illustrated separately, however, the one or more memory devices 302 and the one or more mass storage devices 324 can be regions within the same memory module. The computing device 300 can include one or more additional processors, memory devices, network interfaces, which may be provided separately or on the same chip or board. The one or more memory devices 302 and the one or more mass storage devices 324 can include one or more computer-readable media, including, but not limited to, non-transitory computer-readable media, RAM, ROM, hard drives, flash drives, and/or other memory devices.

The one or more memory devices 302 can store sets of instructions for applications including an operating system that can be associated with various software applications or data. For example, the one or more memory devices 302 can store sets of instructions for applications that can generate output including one or more suggested routes. The one or more memory devices 302 can be used to operate various applications including a mobile operating system developed specifically for mobile devices. As such, the one or more memory devices 302 can store instructions that allow the software applications to access data including data associated with the generation of suggested routes. In other embodiments, the one or more memory devices 302 can be used to operate or execute a general-purpose operating system that operates on both mobile and stationary devices, including for example, smartphones, laptop computing devices, tablet computing devices, and/or desktop computers.

The software applications that can be operated or executed by the computing device 300 can include applications associated with the system 100 shown in FIG. 1A. Further, the software applications that can be operated and/or executed by the computing device 300 can include native applications and/or web-based applications.

The location device 332 can include one or more devices or circuitry for determining the position of the computing device 300. For example, the location device 332 can determine an actual and/or relative position of the computing device 300 by using a satellite navigation positioning system (e.g. a GPS system, a Galileo positioning system, the GLObal Navigation satellite system (GLONASS), the BeiDou Satellite Navigation and Positioning system), an inertial navigation system, a dead reckoning system, based on IP address, by using triangulation and/or proximity to cellular towers or Wi-Fi hotspots, beacons, and the like and/or other suitable techniques for determining position.

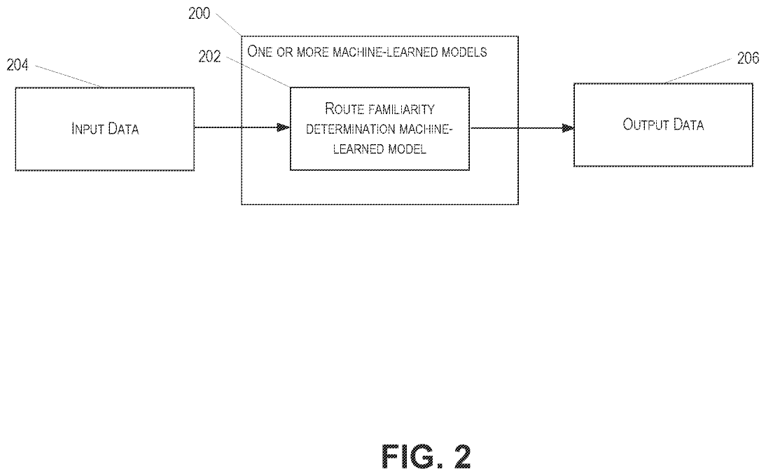

FIG. 4 depicts an example of a route suggestion system according to example embodiments of the present disclosure. A user computing device 400 can include one or more attributes and/or capabilities of the computing device 102, the computing system 130, the training computing system 150, and/or the computing device 300. Furthermore, the user computing device 400 can perform one or more actions and/or operations including the one or more actions and/or operations performed by the computing device 102, the computing system 130, the training computing system 150, and/or the computing device 300.

As shown in FIG. 4, the computing device 400 includes a display component 402, an imaging component 404, an audio input component 406, an audio output component 408, a plurality of control elements 410, a control element 412, a control element 414, and a control element 416.

The computing device 400 can be configured to perform one or more operations including accessing, processing, sending, receiving, and/or generating data including route data and/or historical route data, either of which can be used to generate output including suggested routes that have been ranked according to their respective familiarity to a user. Further, the computing device 400 can receive one or more inputs including one or more interactions from a user of the computing device 400. For example, a user can indicate which of the plurality of control elements 410 represents a suggested route that the user will use to travel to their destination.

In this example, the computing device 400 has determined a set of suggested routes for the user. Further, the computing device 400 has ranked the suggested routes according to and/or based at least in part on their familiarity to the user. The computing device 400 has generated output indicating that “THE ROUTES ARE RANKED ACCORDING TO FAMILIARITY” and requesting the user to “PLEASE SELECT A ROUTE TO THE DESTINATION.” Furthermore, the output can include visual output displayed on the display component 402 and/or auditory output generated by the audio output component 408. The output can include the plurality of control elements 410 which are ranked according to their familiarity to the user. Further, control elements that are associated with higher ranked suggested routes are more prominently displayed. The plurality of control elements 410 can include the control element 412 which includes the indication “MOST FAMILIAR ROUTE” which notifies the user that the control element 412 is associated with a suggested route that was determined to be most familiar to the user. As shown in FIG. 4, the control element 412 includes the largest indication, which is in a large bold font and positioned at the top of the list of routes.

The plurality of control elements 410 can also include the control element 414 which includes the indication “SECOND MOST FAMILIAR ROUTE” which notifies the user that the control element 414 is associated with a suggested route that was determined to be the second most familiar to the user. As shown in FIG. 4, the control element 414 includes the second largest indication, which is in an intermediate sized, non-bold font and positioned in the middle of the list of routes.

The plurality of control elements 410 can also include the control element 416 which includes the indication “THIRD MOST FAMILIAR ROUTE” which notifies the user that the control element 416 is associated with a suggested route that was determined to be the second most familiar to the user. As shown in FIG. 4, the control element 416 includes the third largest indication (the smallest indication), which is small in size and presented in a non-bold font and positioned at the bottom of the list of routes.

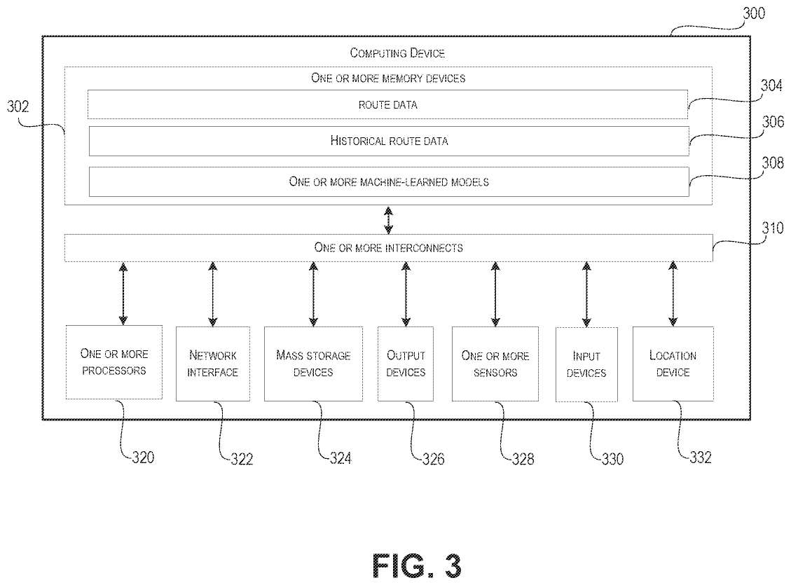

FIG. 5 depicts an example of a route suggestion system according to example embodiments of the present disclosure. A user computing device 500 can include one or more attributes and/or capabilities of the computing device 102, the computing system 130, the training computing system 150, and/or the computing device 300. Furthermore, the user computing device 500 can perform one or more actions and/or operations including the one or more actions and/or operations performed by the computing device 102, the computing system 130, the training computing system 150, and/or the computing device 300.

As shown in FIG. 5, the computing device 500 includes a display component 502, an imaging component 504, an audio input component 506, an audio output component 508, an indication 510, a control element 512, an indication 514, and a control element 516.

The computing device 500 can be configured to perform one or more operations including accessing, processing, sending, receiving, and/or generating data including route data and/or historical route data, either of which can include one or more images of one or more locations. Further, the computing device 500 can receive one or more inputs including one or more interactions from a user of the computing device 500. For example, a user can select a suggested route by selecting the control element 512 or the control element 516.

In this example, the computing device 500 has determined a set of suggested routes for the user and has generated output requesting the user to “PLEASE SELECT A ROUTE TO THE DESTINATION” and can include visual output displayed on the display component 502 and/or auditory output generated by the audio output component 508. The output can include the indication 510 which includes an image of a location that is visible from suggested route 1. The image depicted in the indication 510 can include an image of a location that is determined to be familiar to the user (e.g., an image of the user's office). The control element 512 can be configured to receive an input from the user (e.g., a tap of the user's finger). The user's input to the control element 512 can indicate that the user has selected suggested route 1 to travel to the user's destination.

Furthermore, the output displayed on the display component 502 includes the indication 514 which includes an image of a location that is visible from suggested route 2. The image depicted in the indication 514 can include an image of a location that is determined to be familiar to the user (e.g., an image of a prominent landmark including an obelisk). The control element 514 can be configured to receive an input from the user (e.g., a tap of the user's finger). The user's input to the control element 512 can indicate that the user has selected suggested route 2 to travel to the user's destination.

In some embodiments, selection of suggested route 1 or suggested route 2 can be performed in response to user input to the imaging component 504 (e.g., a camera) which can, for example, capture video imagery of a user's head. The computing device 500 can then perform one or more image recognition operations to determine the suggested route that the user selected based on movements of the user's head. The computing device 700 can use the audio output component 508 to generate an audio output (e.g., a synthetic voice) indicating “WHICH ROUTE WOULD YOU LIKE TO TAKE?” If the user's head nods up and down, suggested route 1 can be selected. If the user's head shakes from side to side (e.g., left to right and back), suggested route 2 can be selected.

Furthermore, selection of suggested route 1 or suggested route 2 can be performed via a user input to the audio input component 506 (e.g., a microphone) which can, for example, detect a user's voice. The computing device 500 can then perform one or more voice recognition operations to determine the suggested route that was selected based on what the user said. The user can select suggested route 1 by saying “TAKE THE ROUTE THAT PASSES BY MY OFFICE” and can select suggested route 2 by saying “TAKE THE ROUTE THAT PASSES BY THE OBELISK.”

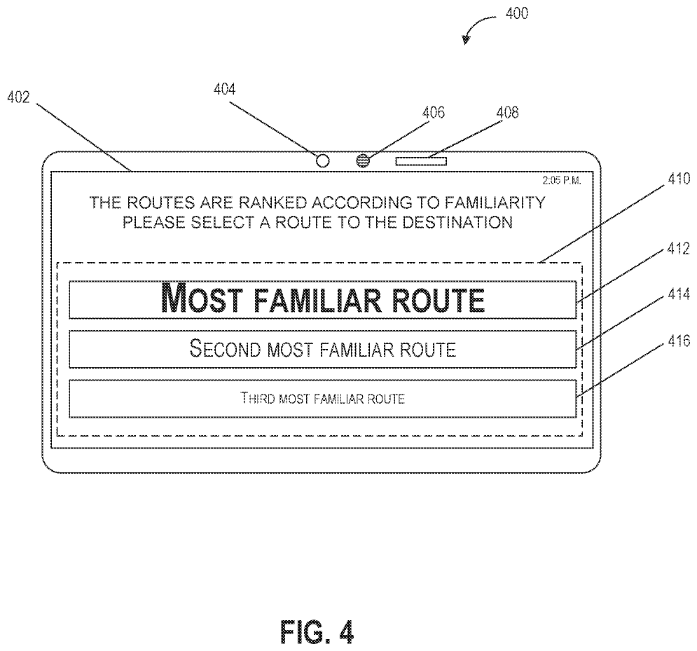

FIG. 6 depicts an example of a route suggestion system according to example embodiments of the present disclosure. A user computing device 600 can include one or more attributes and/or capabilities of the computing device 102, the computing system 130, the training computing system 150, and/or the computing device 300. Furthermore, the user computing device 600 can perform one or more actions and/or operations including the one or more actions and/or operations performed by the computing device 102, the computing system 130, the training computing system 150, and/or the computing device 300.

As shown in FIG. 6, the computing device 600 includes a display component 602, an imaging component 604, an audio input component 606, an audio output component 608, a plurality of control elements 610, a control element 612, a control element 614, and a control element 616.

The computing device 600 can be configured to perform one or more operations including accessing, processing, sending, receiving, and/or generating data including route data and/or historical route data. Further, the computing device 660 can use the route data and/or historical route data to determine a portion of a suggested route that is associated with a particular type of road. Further, the computing device 600 can receive one or more inputs including one or more interactions from a user of the computing device 600. For example, a user can select a suggested route by selecting any of the plurality of control elements 610.

In this example, the computing device 600 has determined a set of suggested routes for the user. Further, the computing device 600 has ranked the suggested routes according to and/or based at least in part on their familiarity to the user. The computing device 600 has determined the portion of the suggested routes that is associated with one or more types of road and generated output indicating that “THE PREDOMINANT TYPE OF ROAD IS INDICATED” and requesting the user to “PLEASE SELECT A ROUTE TO THE DESTINATION.”

Furthermore, the output can include visual output displayed on the display component 602 and/or auditory output generated by the audio output component 608. The output can include the plurality of control elements 610 each of which includes a respective indication of the amount and/or portion of the suggested route that includes a particular type of road. The plurality of control elements 610 can include the control element 612 which includes the indication “SUGGESTED ROUTE 1—85% HIGHWAY” which notifies the user that the control element 612 is associated with a suggested route has a road type that is eighty-five percent (85%) highway with the remaining fifteen percent (15%) including other types of roads.

The plurality of control elements 610 can include the control element 614 which includes the indication “SUGGESTED ROUTE 2—55% HIGHWAY” which notifies the user that the control element 614 is associated with a suggested route has a road type that is fifty-five percent (55%) highway with the remaining forty-five percent (45%) including other types of roads.

The plurality of control elements 610 can include the control element 616 which includes the indication “SUGGESTED ROUTE 3—75% CITY STREETS” which notifies the user that the control element 616 is associated with a suggested route has a road type that is seventy-five percent (75%) city streets in an urban environment with the remaining twenty-five percent (25%) of the suggested route including other types of roads.

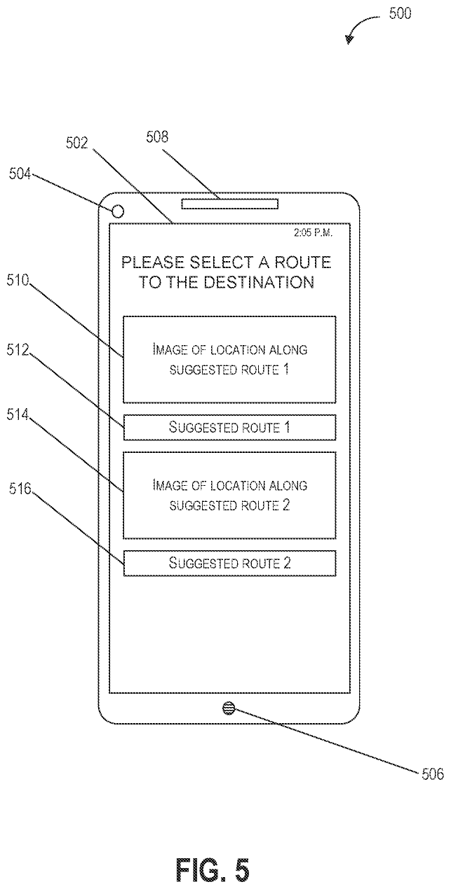

FIG. 7 depicts an example of a route suggestion system according to example embodiments of the present disclosure. A user computing device 700 can include one or more attributes and/or capabilities of the computing device 102, the computing system 130, the training computing system 150, and/or the computing device 300. Furthermore, the user computing device 700 can perform one or more actions and/or operations including the one or more actions and/or operations performed by the computing device 102, the computing system 130, the training computing system 150, and/or the computing device 300.

As shown in FIG. 7, the computing device 700 includes a display component 702, an imaging component 704, an audio input component 706, an audio output component 708, an indication 710, a control element 712, an indication 714, and a control element 716.

The computing device 700 can be configured to perform one or more operations including accessing, processing, sending, receiving, and/or generating data including route data and/or historical route data. Further, the computing device 700 can receive one or more inputs including one or more interactions from a user of the computing device 700. For example, a user can indicate a suggested route that is preferred by interacting with the computing device 700.

In this example, the computing device 700 has determined a set of suggested routes for the user and has generated output requesting the user to “PLEASE SELECT A ROUTE TO THE DESTINATION.” Further, the output can include visual output displayed on the display component 702 and/or auditory output generated by the audio output component 708. The output can include the indication 710 which states “SUGGESTED ROUTE 1 PASSES BY YOUR OFFICE” thereby notifying the user that suggested route 1 passes by the office of the user, which is a location that the user is very familiar with due to the user driving to the office hundreds of times per year. The control element 712 can be configured to receive an input from the user (e.g., a tactile input from the user's finger). The user's input to the control element 712 can indicate that the user has selected suggested route 1 to travel to the user's destination.

Furthermore, the output displayed on the display component 702 includes the indication 714 which states “SUGGESTED ROUTE 2 PASSES BY POINT PLEASANT PARK” thereby notifying the user that suggested route 1 passes by Point Pleasant Park, which is a large park that the user visits three to four times a year during the summer months, and which is a location that the user less familiar with than the location of the user's office. The control element 716 can be configured to receive an input from the user (e.g., the user pressing the control element 716). The user's input to the control element 716 can indicate that the user has selected suggested route 2 to travel to the user's destination.

In some embodiments, selection of suggested route 1 or suggested route 2 can be performed via a user input to the imaging component 704 (e.g., a camera) which can, for example, capture an image of a user's hand. The computing device 700 can then perform one or more image recognition operations to determine the suggested route that the user selected based on the gesture that is depicted in the image of the user's hand. If the user holds up one finger, suggested route 1 can be selected. If the user holds up two fingers, suggested route 2 can be selected. Furthermore, selection of suggested route 1 or suggested route 2 can be performed via a user input to the audio input component 706 (e.g., a microphone) which can, for example, detect a user's voice. The computing device 700 can then perform one or more voice recognition operations to determine the suggested route that was selected based on what the user said. The user can select suggested route 1 by saying “SELECT SUGGESTED ROUTE 1” and can select suggested route 2 by saying “SELECT SUGGESTED ROUTE 2.”

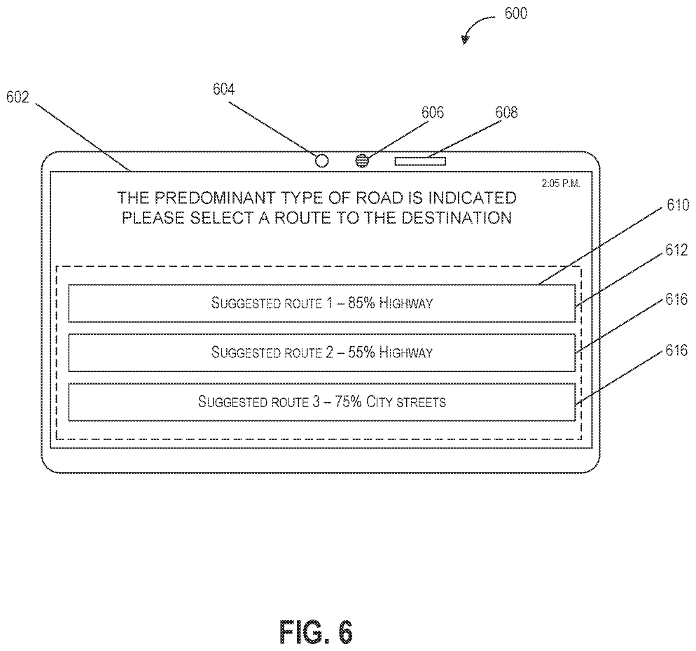

FIG. 8 depicts an example of a route suggestion system according to example embodiments of the present disclosure. A user computing device 800 can include one or more attributes and/or capabilities of the computing device 102, the computing system 130, the training computing system 150, and/or the computing device 300. Furthermore, the user computing device 800 can perform one or more actions and/or operations including the one or more actions and/or operations performed by the computing device 102, the computing system 130, the training computing system 150, and/or the computing device 300.

As shown in FIG. 8, the computing device 800 includes a display component 802, an audio input component 806, an audio output component 808, an indication 810, a control element 812, an indication 814, and a control element 816.

The computing device 800 can be configured to perform one or more operations including accessing, processing, sending, receiving, and/or generating data including route data and/or historical route data. Further, the computing device 800 can use the route data and/or the historical route data to determine an amount of similarity between a suggested route and a previously traveled route. Additionally, the computing device 800 can provide an indication of how fast a route is relative to the fastest route to the destination. Further, the computing device 800 can receive one or more inputs including one or more interactions from a user of the computing device 800. For example, a user can indicate their preferred route via one or more interactions with the computing device 800.

In this example, the computing device 800 has determined a set of suggested routes for the user and has generated output requesting the user to “PLEASE SELECT A ROUTE TO THE DESTINATION” and can include visual output displayed on the display component 802 and/or auditory output generated by the audio output component 808. The output can include the indication 810 which states “ROUTE 1 IS 65% SIMILAR TO A ROUTE YOU HAVE PREVIOUSLY TRAVELED” and gives the user an indication of how familiar suggested route 1 is to the user. Further, the indication 810 notifies the user of the trade-off between similarity and travel time by indicating that suggested route 1 “WILL TAKE 10 MINUTES LONGER THAN THE FASTEST ROUTE.” The control element 812 can be configured to receive an input from the user (e.g., the user touching control element 812). The user's input to the control element 812 can indicate that the user has selected suggested route 1 to travel to the user's destination.

Furthermore, the indication 814 states “ROUTE 2 IS 45% SIMILAR TO A ROUTE YOU HAVE PREVIOUSLY TRAVELED” and gives the user an indication of how familiar suggested route 2 is to the user. Further, the indication 814 notifies the user of the trade-off between similarity and travel time by indicating that suggested route 2 “WILL TAKE 10 MINUTES LONGER THAN THE FASTEST ROUTE.” The control element 816 can be configured to receive an input from the user (e.g., the user touching control element 816). The user's input to the control element 816 can indicate that the user has selected suggested route 2 to travel to the user's destination.

In some embodiments, selection of suggested route 1 or suggested route 2 can be performed via a user input to the audio input component 806 (e.g., a microphone) which can, for example, detect a user's voice. The computing device 800 can then perform one or more voice recognition operations to determine the suggested route that was selected based on what the user said. The user can select suggested route 1 by saying “TAKE THE LONGER ROUTE” or “TAKE THE MORE FAMILIAR ROUTE.” Alternatively, the user can select suggested route 2 by saying “TAKE THE FASTER ROUTE.”

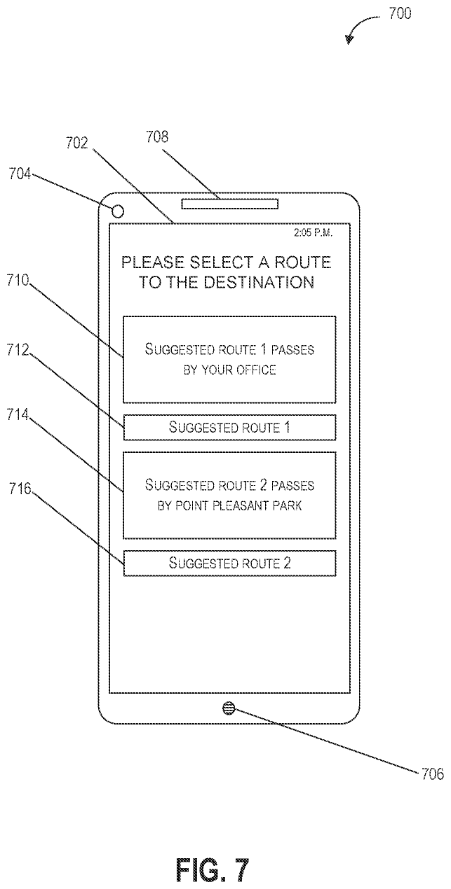

FIG. 9 depicts an example of a route suggestion system according to example embodiments of the present disclosure. A user computing device 900 can include one or more attributes and/or capabilities of the computing device 102, the computing system 130, the training computing system 150, and/or the computing device 300. Furthermore, the user computing device 900 can perform one or more actions and/or operations including the one or more actions and/or operations performed by the computing device 102, the computing system 130, the training computing system 150, and/or the computing device 300.

As shown in FIG. 9, the computing device 900 includes a display component 902, an imaging component 904, an audio input component 906, an audio output component 908, a plurality of control elements 910, a control element 912, a control element 914, and a control element 916.

The computing device 900 can be configured to perform one or more operations including accessing, processing, sending, receiving, and/or generating data including route data and/or historical route data. Further, the computing device 900 can be configured to generate a prompt including a request for feedback from a user. In some embodiments, the prompt can be generated when a user arrives at a destination. Further, the computing device 900 can receive one or more inputs including one or more interactions from a user of the computing device 900. For example, a user can provide input including feedback regarding how familiar the route that the user just traveled was.

In this example, the computing device 900 has generated output including a prompt asking the user “HOW FAMILIAR WAS THE ROUTE THAT YOU JUST TRAVELED?” and can include visual output displayed on the display component 902 and/or auditory output generated by the audio output component 908. The output can include the plurality of control elements 910 which can be used by a user to indicate how familiar the user was with the route that the user just traveled. The control element 912 can include an indication that the traveled route was “VERY FAMILIAR” to the user. The control element 914 can include an indication that the traveled route was “SOMEWHAT FAMILIAR” to the user. The control element 916 can include an indication that the traveled route was “NOT FAMILIAR AT ALL” to the user.

The user's input to the control elements 912/914/916 is feedback that can be used to determine how familiar a route actually was to the user. Based on the user's feedback, the computing device 900 can adjust and/or modify the route data, the historical route data, and/or one or more machine-learned models that are used to determine the similarity and/or familiarity of a route.

Furthermore, a user's feedback to the prompt requesting how familiar the traveled route was to the user can be received via a user input to the audio input component 906 (e.g., a microphone) which can, for example, detect a user's voice. The computing device 900 can then perform one or more voice recognition operations to determine the feedback provided by the user based on what the user said in response to the prompt. The user can reply to an audio output generated by the audio output component 908 by saying how familiar the route was to the user (e.g., the user can say the route was very familiar, somewhat familiar, or not familiar at all).

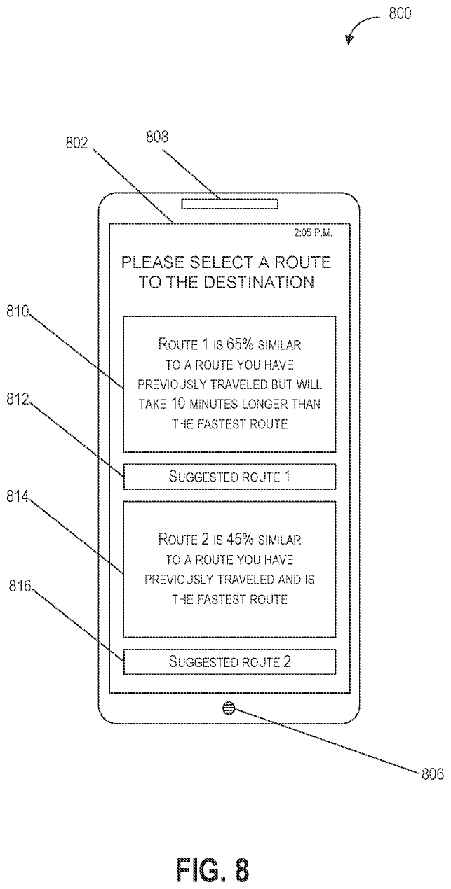

FIG. 10 depicts a flow diagram of the generation of suggested routes according to example embodiments of the present disclosure. One or more portions of the method 1000 can be executed and/or implemented on one or more computing devices or computing systems including, for example, the computing device 102, the computing system 130, the training computing system 150, and/or the computing device 300. Further, one or more portions of the method 1000 can be executed or implemented as an algorithm on the hardware devices or systems disclosed herein. FIG. 10 depicts steps performed in a particular order for purposes of illustration and discussion. Those of ordinary skill in the art, using the disclosures provided herein, will understand that various steps of any of the methods disclosed herein can be adapted, modified, rearranged, omitted, and/or expanded without deviating from the scope of the present disclosure.

At 1002, the method 1000 can include accessing data which can include route data. The route data can include information associated with a starting location and/or a destination. For example, the computing device 102 can access locally stored route data that includes information associated with the a starting location (e.g., the current location of the computing device 102) and a destination that a user has selected or determined.

At 1004, the method 1000 can include determining, based at least in part on the route data, one or more routes from the starting location to the destination. For example, the computing device 102 can analyze one or more maps of a geographic area that includes the starting location and the destination. Further, the computing device 102 can determine the one or more routes from the starting location to the destination by determining the one or more roads that connect the starting location and the destination.

At 1006, the method 1000 can include determining, based at least in part on historical route data, one or more amounts of familiarity with one or more historical routes that were previously traveled by a user. For example, the computing device 102 can determine one or more amounts of familiarity with one or more historical routes based on accessing historical route data that includes predetermined information (e.g., one or more amounts of familiarity associated with one or more historical routes, that are periodically updated after each route a user travels) about a user's familiarity with one or more historical routes.

At 1008, the method 1000 can include determining one or more similarities and/or one or more amounts of similarity between the one or more routes and the one or more historical routes. For example, the computing device 102 can perform one or more operations including one or more comparisons of various features of the one or more routes and the one or more historical routes. The various features of the one or more routes and the one or more historical routes that are compared can include distance, the set of locations, the types of roads, and/or the modes of travel a user uses to travel. Based on the one or more comparisons of the various features, the computing device 102 can determine the one or more similarities and/or the one or more amounts of similarity between the one or more routes and the one or more historical routes.

At 1010, the method 1000 can include determining one or more suggested routes based at least in part on the one or more routes that satisfy one or more criteria associated with the one or more amounts of familiarity and the one or more similarities. For example, the computing device 102 can determine the one or more suggested routes based at least in part on a predetermined number (e.g., three) of the one or more routes that exceed a predetermined amount of familiarity and/or exceed a predetermined amount of similarity.

At 1012, the method 1000 can include generating output including one or more indications associated with the user traveling the one or more suggested routes. For example, the computing device 102 can include a display component that is used to display the one or more suggested routes and information associated with an estimated travel time to travel each of the one or more suggested routes respectively.

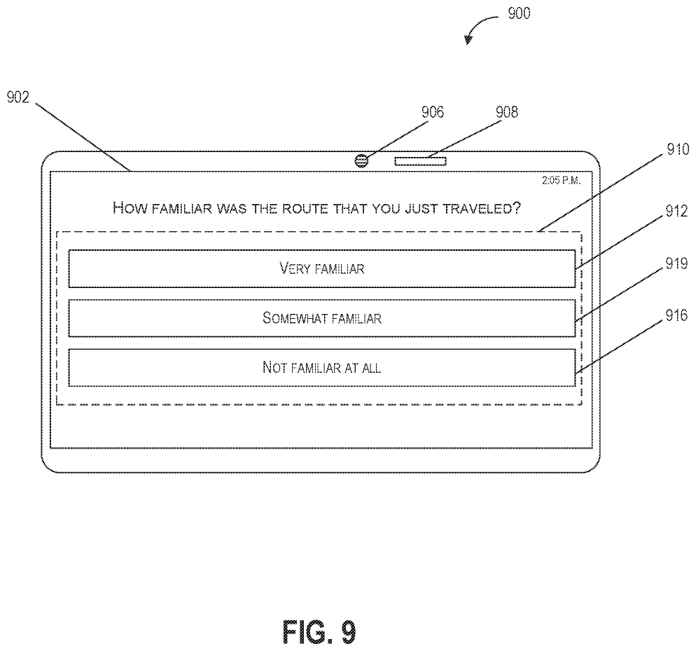

FIG. 11 depicts a flow diagram of the generation of suggested routes according to example embodiments of the present disclosure. One or more portions of the method 1100 can be executed and/or implemented on one or more computing devices or computing systems including, for example, the computing device 102, the computing system 130, the training computing system 150, and/or the computing device 300. Further, one or more portions of the method 1100 can be executed or implemented as an algorithm on the hardware devices or systems disclosed herein. In some embodiments, one or more portions of the method 1100 can be performed as part of the method 1000 that is depicted in FIG. 10. FIG. 11 depicts steps performed in a particular order for purposes of illustration and discussion. Those of ordinary skill in the art, using the disclosures provided herein, will understand that various steps of any of the methods disclosed herein can be adapted, modified, rearranged, omitted, and/or expanded without deviating from the scope of the present disclosure.

At 1102, the method 1100 can include determining a ranking of the one or more suggested routes based at least in part on the one or more similarities. For example, the computing device 102 can rank the one or more suggested routes based at least in part on the one or more routes that are most similar to the one or more historical routes such that the one or more suggested routes that are more similar to the one or more historical routes are ranked higher.

In some embodiments, the ranking of the one or more suggested routes can be based at least in part on one or more user preferences. The one or more user preferences can include a maximum distance of a suggested route, a maximum travel time of a suggested route, a preferred type of road, and/or a preferred mode of travel. The computing device 102 can, for example, rank the one or more suggested routes based at least in part on the distances of the one or more suggested routes.

At 1104, the method 1100 can include presenting the one or more suggested routes in an order based at least in part on the ranking. For example, the computing device 102 can generate output including one or more indications associated with ranking of the one or more suggested routes. For example, the computing device 102 can include a display component that is used to display the one or more suggested routes in order from the shortest suggested route to the longest suggested route.

At 1106, the method 1100 can include determining the one or more suggested routes that the user previously traveled. For example, the computing device 102 can access the historical route data to determine the one or more suggested routes that have a common set of locations with the one or more historical routes. The common set of locations can indicate that the one or more suggested routes were previously traveled by the user.

At 1108, the method 1100 can include generating one or more indications of the one or more suggested routes that the user previously traveled. For example, the computing device 102 can generate output including one or more indications associated with the one or more suggested routes that were previously traveled by the user. For example, the computing device 102 can include an audio output component (e.g., loudspeakers) that is used to announce the one or more suggested routes that the user had previously traveled.

At 1110, the method 1100 can include determining one or more modes of travel associated with the user and/or the one or more suggested routes. The computing device 102 can determine that the user is using an automobile and access the historical route data to determine the one or more modes of travel that are associated with each of the one or more historical routes. The computing device 102 can determine the one or more modes of travel associated with the user based on user input (e.g., the user indicating the mode of travel that they are using) and/or a determination based on the type of vehicle that the user is detected to be using (e.g., based on motion characteristics that can be detected using accelerometers and/or global positioning satellite data).

At 1112, the method 1100 can include generating one or more indications of the one or more suggested routes that use a mode of travel that is the same or similar to the one or more modes of travel associated with the user. For example, the computing device 102 can generate output including one or more indications of the one or more suggested routes associated with traveling by automobile.

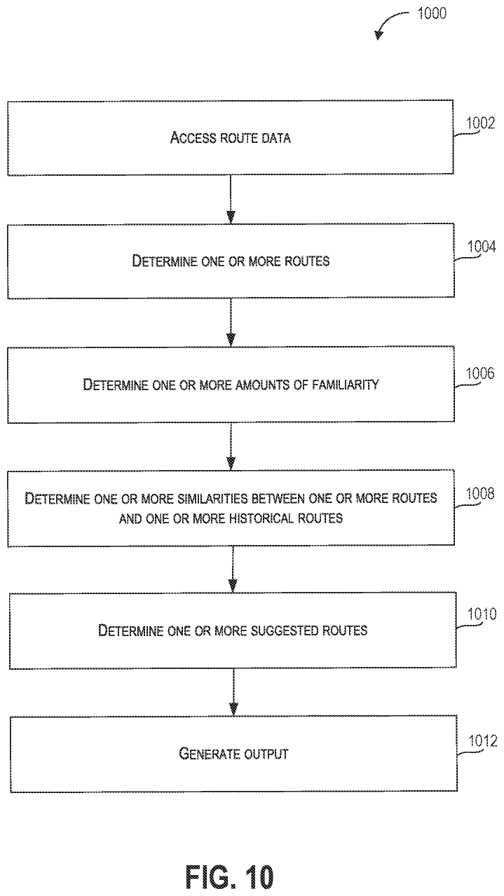

FIG. 12 depicts a flow diagram of the generation of suggested routes according to example embodiments of the present disclosure. One or more portions of the method 1200 can be executed and/or implemented on one or more computing devices or computing systems including, for example, the computing device 102, the computing system 130, the training computing system 150, and/or the computing device 300. Further, one or more portions of the method 1200 can be executed or implemented as an algorithm on the hardware devices or systems disclosed herein. In some embodiments, one or more portions of the method 1200 can be performed as part of the method 1000 that is depicted in FIG. 10. FIG. 12 depicts steps performed in a particular order for purposes of illustration and discussion. Those of ordinary skill in the art, using the disclosures provided herein, will understand that various steps of any of the methods disclosed herein can be adapted, modified, rearranged, omitted, and/or expanded without deviating from the scope of the present disclosure.

At 1202, the method 1200 can include determining the one or more suggested routes that include one or more locations that the user has traveled to more than a threshold number of times. For example, the computing device 102 can access the route data and/or the historical route data, either or both of which can include information associated with how many times a user has traveled to one or more locations. The computing device 102 can then determine the one or more locations that are also included in the one or more suggested routes and which have been traveled to more than the threshold number of times.

At 1204, the method 1200 can include generating, by the computing system, the one or more indications of the one or more locations that the user has traveled to more than the threshold number of times. For example, if the threshold number of times is four (4) a suggested route that the user traveled six (6) times can result in the computing device 102 generating an audible output that the user traveled six (6) times to a location along the suggested route.

At 1206, the method 1200 can include determining the one or more suggested routes that satisfy one or more similarity criteria and/or were traveled by the user in a direction that is different from a direction of travel of the one or more historical routes. For example, the computing device 102 can access the route data and/or the historical route data, either or both of which can include information associated with a user's direction of travel along one or more routes including the one or more historical routes and/or the one or more suggested routes. The computing device 102 can then determine the one or more suggested routes that satisfy the one or more similarity criteria and have a direction of travel that is different from the one or more historical routes.

At 1208, the method 1200 can include generating one or more indications of the one or more suggested routes that satisfy the one or more similarity criteria and were traveled by the user in a direction of travel that is different from the direction of travel of the one or more historical routes. For example, the computing device 102 can generate one or more visual indications including the one or more suggested routes and text indicating that the user had previously traveled the one or more suggested routes in a different direction.

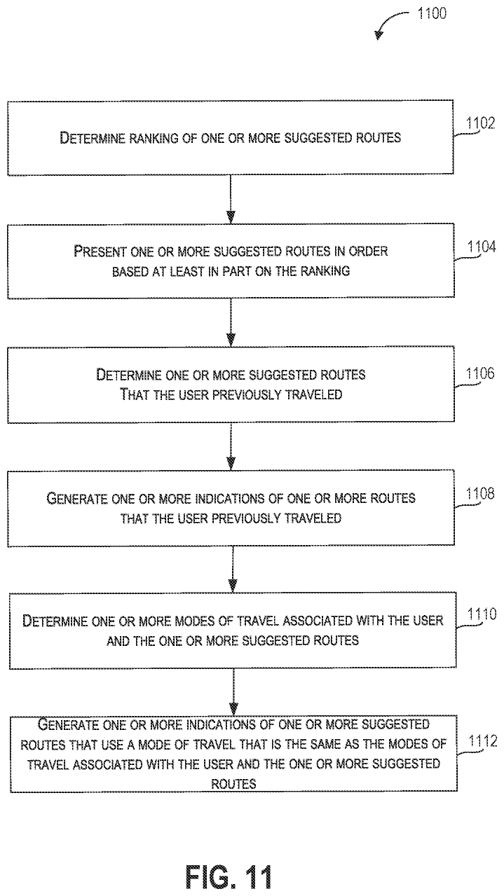

FIG. 13 depicts a flow diagram of the generation of suggested routes according to example embodiments of the present disclosure. One or more portions of the method 1300 can be executed and/or implemented on one or more computing devices or computing systems including, for example, the computing device 102, the computing system 130, the training computing system 150, and/or the computing device 300. Further, one or more portions of the method 1300 can be executed or implemented as an algorithm on the hardware devices or systems disclosed herein. In some embodiments, one or more portions of the method 1300 can be performed as part of the method 1000 that is depicted in FIG. 10. FIG. 13 depicts steps performed in a particular order for purposes of illustration and discussion. Those of ordinary skill in the art, using the disclosures provided herein, will understand that various steps of any of the methods disclosed herein can be adapted, modified, rearranged, omitted, and/or expanded without deviating from the scope of the present disclosure.

At 1302, the method 1300 can include determining one or more types of road associated with the one or more suggested routes. For example, the computing device 102 can access the route data and/or the historical route data to determine the one or more types of road that are associated with the one or more suggested routes.

At 1304, the method 1300 can include determining, based at least in part on the historical route data, whether the one or more suggested roads include one or more types of road that the user is familiar with. For example, the computing device 102 can use the historical data to determine based at least in part on the frequency and/or recency of the user traveling the one or more historical routes, the one or more types of road that the user is familiar with. For example, if a user frequently cycles through urban roads (e.g., city streets) in densely populated areas, the computing device 102 can determine that the user is more familiar with such roads.

At 1306, the method 1300 can include generating one or more indications of the one or more suggested routes that use the one or more types of road that are the same as or similar to the one or more types of road that the user is familiar with. The computing device 102 can generate one or more auditory indications including an announcement that a particular suggested route uses a familiar type of road. For example, the computing device 102 can indicate that a suggested route is primarily on the highway.

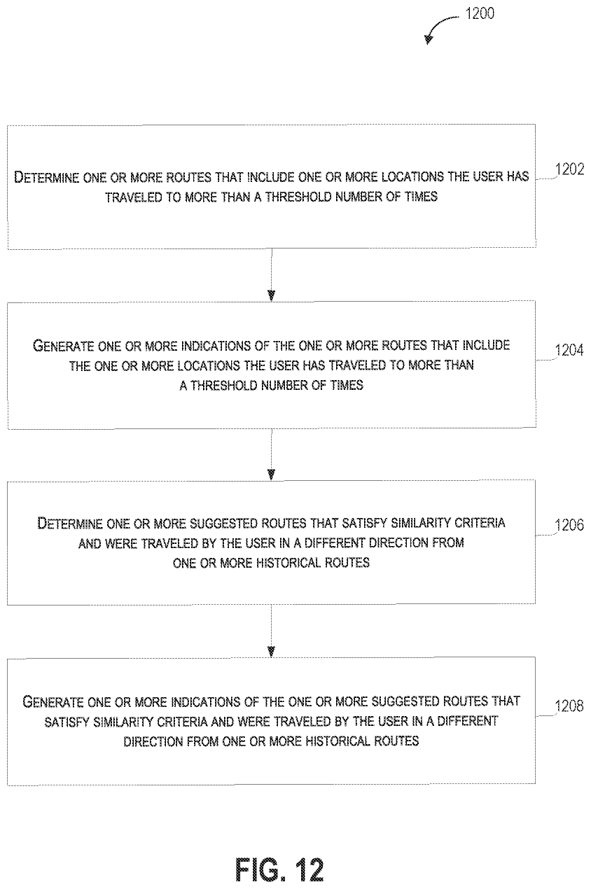

FIG. 14 depicts a flow diagram of the generation of suggested routes according to example embodiments of the present disclosure. One or more portions of the method 1400 can be executed and/or implemented on one or more computing devices or computing systems including, for example, the computing device 102, the computing system 130, the training computing system 150, and/or the computing device 300. Further, one or more portions of the method 1400 can be executed or implemented as an algorithm on the hardware devices or systems disclosed herein. In some embodiments, one or more portions of the method 1400 can be performed as part of the method 1000 that is depicted in FIG. 10. FIG. 14 depicts steps performed in a particular order for purposes of illustration and discussion. Those of ordinary skill in the art, using the disclosures provided herein, will understand that various steps of any of the methods disclosed herein can be adapted, modified, rearranged, omitted, and/or expanded without deviating from the scope of the present disclosure.

At 1402, the method 1400 can include determining one or more features of the one or more routes that are similar to one or more features of the one or more historical routes. For example, the computing device 102 can access the route data and the historical route data to determine the one or more features (e.g., distance, locations, and/or type of road) of the one or more routes that are similar to one or more features of the one or more historical routes.

At 1404, the method 1400 can include determining the one or more similarities between the one or more routes and the one or more historical routes based at least in part on one or more machine-learned models. The one or more machine-learned models can be configured to determine the one or more similarities between the one or more routes and the one or more historical routes. For example, the computing device 102 can use one or more machine-learned models to determine the one or more features (e.g., visual features) of the one or more routes that are similar to one or more features of the one or more historical routes.

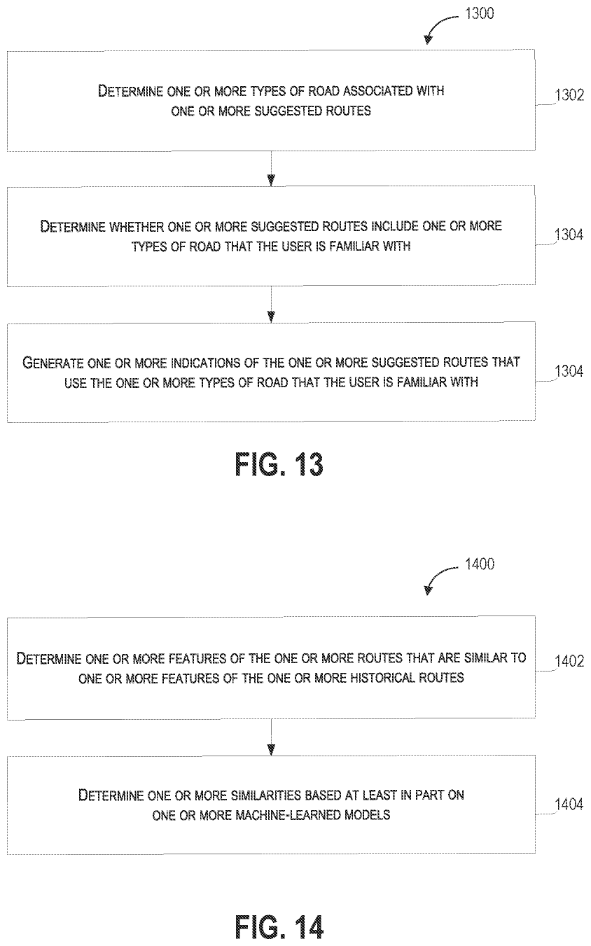

FIG. 15 depicts a flow diagram of the generation of suggested routes according to example embodiments of the present disclosure. One or more portions of the method 1500 can be executed and/or implemented on one or more computing devices or computing systems including, for example, the computing device 102, the computing system 130, the training computing system 150, and/or the computing device 300. Further, one or more portions of the method 1500 can be executed or implemented as an algorithm on the hardware devices or systems disclosed herein. In some embodiments, one or more portions of the method 1500 can be performed as part of the method 1000 that is depicted in FIG. 10. FIG. 15 depicts steps performed in a particular order for purposes of illustration and discussion. Those of ordinary skill in the art, using the disclosures provided herein, will understand that various steps of any of the methods disclosed herein can be adapted, modified, rearranged, omitted, and/or expanded without deviating from the scope of the present disclosure.

At 1502, the method 1500 can include generating a prompt requesting feedback. The feedback can be associated with an amount of familiarity that the user has with at least one suggested route of the one or more suggested routes. For example, the computing device 102 can generate a prompt asking the user to indicate “YES OR NO” whether a suggested route appears to be familiar or to rate the familiarity of a suggested route from one (1) to ten (10).

At 1504, the method 1500 can include adjusting the historical route data based at least in part on the feedback. The historical route data can include information associated with the amount of familiarity a user has with one or more historical routes and/or one or more locations. The feedback from the user can be used to update the amount of familiarity associated with the suggested route that was included in the prompt.

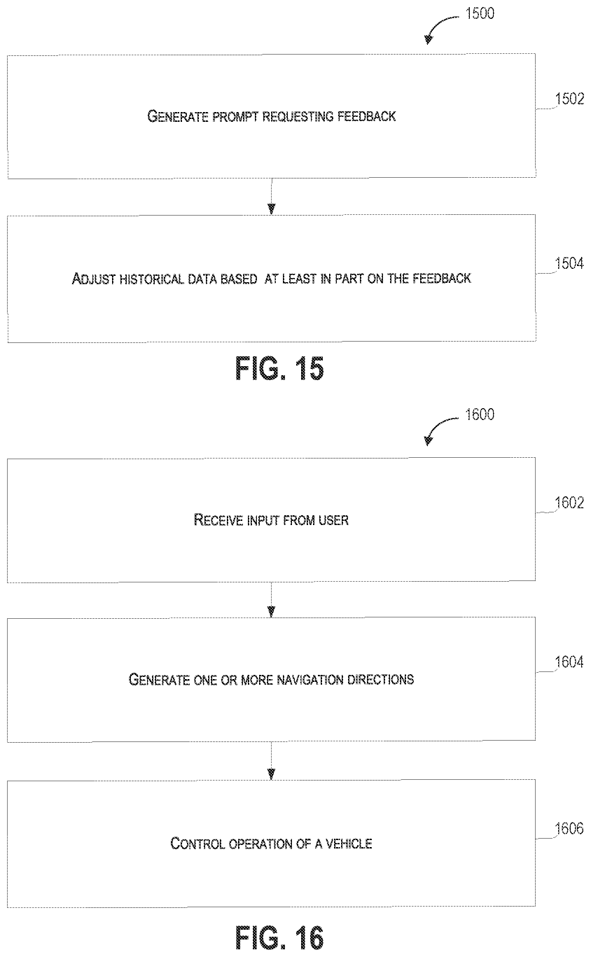

FIG. 16 depicts a flow diagram of the generation of suggested routes according to example embodiments of the present disclosure. One or more portions of the method 1600 can be executed and/or implemented on one or more computing devices or computing systems including, for example, the computing device 102, the computing system 130, the training computing system 150, and/or the computing device 300. Further, one or more portions of the method 1600 can be executed or implemented as an algorithm on the hardware devices or systems disclosed herein. In some embodiments, one or more portions of the method 1600 can be performed as part of the method 1000 that is depicted in FIG. 10. FIG. 16 depicts steps performed in a particular order for purposes of illustration and discussion. Those of ordinary skill in the art, using the disclosures provided herein, will understand that various steps of any of the methods disclosed herein can be adapted, modified, rearranged, omitted, and/or expanded without deviating from the scope of the present disclosure.

At 1602, the method 1600 can include receiving an input from a user. The input can include a user selected route that is selected from the one or more suggested routes. For example, the computing device 102 can include a touch sensitive display device that displays the one or more suggested routes. The user can then touch the suggested route that the user intends to travel. In some embodiments, the computing device can receive an audio input (e.g., the user speaking) that indicates the user's selection of a particular suggested route. In some embodiments, the computing device 102 can include natural language processing capabilities that can be used to select a suggested route based on the semantics of the user's spoken instructions. For example, the user can say “TAKE THE SCENIC ROUTE” and the computing device 102 can select a suggested route that passes by the oceanside or historic buildings.

At 1604, the method 1600 can include generating one or more navigation directions from the starting location to the destination along the user selected route. For example, the computing device 102 can use the user selected route to determine the one or more navigable roads (e.g., roads that the user can travel using their current mode of transportation while following traffic regulations) between the starting location and the destination. The computing device 102 can then determine one or more navigation directions which can include one or more instructions of the manner in which the user can follow the user selected route.

For example, the one or more navigation directions can include one or more locations (e.g., geographical locations which can include a latitude, longitude, and/or altitude; and/or a bearing and distance relative to the current position of the user) and/or street addresses to which the user can travel to follow the user selected route. In some embodiments, the one or more navigation directions can include turn-by-turn instructions that include one or more visual indications (e.g., written instructions) and/or one or more auditory instructions (e.g., a synthetic voice that generates instructions via an audio output device) that can indicate where the user and/or a device associated with the user should go relative to the user's current location. Further, the one or more navigation directions can include directions to a user that indicate one or more portions of the user selected route that may be familiar to the user. For example, the one or more navigation directions can direct the user to travel to a location that was determined to be familiar to the user.

Further, the one or more navigation directions can include one or more instructions that indicate how a vehicle (e.g., an autonomous vehicle) should operate along the user selected route. For example, the one or more navigation directions can indicate the operations of various electronic and/or mechanical systems of a vehicle that should be performed as the vehicle travels along a route including accelerating, decelerating, braking, turning, a direction of travel (e.g., a bearing of the vehicle or a direction relative to one or more objects detected by one or more sensors of the vehicle), and/or a speed at which a vehicle should travel at different portions of the user selected route.

At 1606, the method 1600 can include controlling operation of a vehicle based at least in part on the user selected route and/or the one or more navigation directions. Operation of the vehicle can include navigating the vehicle from the starting location to the destination along the user selected route in accordance with the one or more navigation directions.

For example, the computing device 102 can be associated with an autonomous vehicle control system that is used to control the operation of an autonomous vehicle. The computing device 102 can then control the movement of the autonomous vehicle between the starting location and the destination based at least in part on the one or more locations indicated in the one or more navigation directions. In some embodiments, the computing device 102 can use the same route that was traveled in subsequent routes between the starting location and the destination. The computing device 102 can also utilize the navigation directions used for one or more routes that have been previously traveled in order to travel along subsequent routes.

The technology discussed herein makes reference to servers, databases, software applications, and other computer-based systems, as well as actions taken and information sent to and from such systems. The inherent flexibility of computer-based systems allows for a great variety of possible configurations, combinations, and divisions of tasks and functionality between and among components. For instance, processes discussed herein can be implemented using a single device or component or multiple devices or components working in combination. Databases and applications can be implemented on a single system or distributed across multiple systems. Distributed components can operate sequentially or in parallel.

While the present subject matter has been described in detail with respect to various specific example embodiments thereof, each example is provided by way of explanation, not limitation of the disclosure. Those skilled in the art, upon attaining an understanding of the foregoing, can readily produce alterations to, variations of, and equivalents to such embodiments. Accordingly, the subject disclosure does not preclude inclusion of such modifications, variations and/or additions to the present subject matter as would be readily apparent to one of ordinary skill in the art. For instance, features illustrated or described as part of one embodiment can be used with another embodiment to yield a still further embodiment. Thus, it is intended that the present disclosure cover such alterations, variations, and equivalents.

1. A computer-implemented method of navigation, the computer-implemented method comprising:
accessing, by a computing system comprising one or more processors, route data comprising information associated with a starting location and a destination;
determining, by the computing system, based at least in part on the route data, one or more routes from the starting location to the destination;
determining, by the computing system, based at least in part on historical route data, one or more amounts of familiarity with one or more historical routes that were previously traveled by a user;
determining, by the computing system, one or more similarities between the one or more routes and the one or more historical routes;
determining, by the computing system, one or more suggested routes based at least in part on the one or more routes that satisfy one or more criteria associated with the one or more amounts of familiarity and the one or more similarities; and
generating, by the computing system, output comprising one or more indications associated with the user traveling the one or more suggested routes.

2. The computer-implemented method of claim 1, further comprising:
determining, by the computing system, a ranking of the one or more suggested routes based at least in part on the one or more similarities; and
presenting, by the computing system, the one or more suggested routes in an order based at least in part on the ranking.

3. The computer-implemented method of claim 2, wherein the suggested route with the highest ranking is emphasized, and wherein the emphasis comprises emphasis of a visual property of an indication associated with the suggested route with the highest ranking, an indication including a description of the suggested route with the highest ranking, or a larger size of an indication associated with the suggested route with the highest ranking.

4. The computer-implemented method of claim 1, further comprising:
determining, by the computing system, the one or more suggested routes that the user previously traveled; and
generating, by the computing system, one or more indications of the one or more suggested routes that the user previously traveled.

5. The computer-implemented method of claim 4, wherein the one or more indications of the one or more suggested routes that the user previously traveled comprise one or more images of one or more locations that are visible from the one or more suggested routes that the user previously traveled.

6. The computer-implemented method of claim 1, further comprising:
determining, by the computing system, one or more types of road associated with the one or more suggested routes, wherein the one or more types of road comprise a highway, an urban road, a suburban road, or a rural road;
determining, by the computing system, based at least in part on the historical route data, whether the one or more suggested roads include one or more types of road that the user is familiar with; and
generating, by the computing system, one or more indications of the one or more suggested routes that use the one or more types of road that are the same as the one or more types of road that the user is familiar with.

7. The computer-implemented method of claim 1, further comprising:
determining, by the computing system, the one or more suggested routes that include one or more locations that the user has traveled to more than a threshold number of times; and
generating, by the computing system, the one or more indications of the one or more locations that the user has traveled to more than the threshold number of times.

8. The computer-implemented method of claim 1, further comprising:
determining, by the computing system, the one or more suggested routes that satisfy one or more similarity criteria and were traveled by the user in a direction that is different from a direction of travel of the one or more historical routes; and
generating, by the computing system, one or more indications of the one or more suggested routes that satisfy the one or more similarity criteria and were traveled by the user in a direction of travel that is different from the direction of travel of the one or more historical routes.

9. The computer-implemented method of claim 1, further comprising:
determining, by the computing system, one or more modes of travel associated with the user and the one or more suggested routes, wherein the one or more modes of travel comprise foot travel, automobile travel, or cycling; and
generating, by the computing system, one or more indications of the one or more suggested routes that use a mode of travel that is the same as the one or more modes of travel associated with the user.

10. The computer-implemented method of claim 1, wherein the determining, by the computing system, one or more similarities between the one or more routes and the one or more historical routes comprises:
determining, by the computing system, one or more features of the one or more routes that are similar to one or more features of the one or more historical routes.

11. The computer-implemented method of claim 10, wherein the one or more features of the one or more routes that are similar to one or more features of the one or more historical routes comprise one or more visual features associated with one or more roads, or one or more visual features associated with one or more areas that are visible from the one or more roads.

12. The computer-implemented method of claim 1, wherein the determining, by the computing system, one or more similarities between the one or more routes and the one or more historical routes comprises:
determining, by the computing system, the one or more similarities between the one or more routes and the one or more historical routes based at least in part on one or more machine-learned models configured to determine the one or more similarities between the one or more routes and the one or more historical routes.

13. The computer-implemented method of claim 1, wherein the one or more indications associated with traveling the one or more suggested routes comprise one or more portions of the one or more suggested routes that overlap one or more portions of the one or more historical routes.

14. The computer-implemented method of claim 1, further comprising:
generating, by the computing system, a prompt requesting feedback comprising an amount of familiarity that the user has with at least one suggested route of the one or more suggested routes; and
adjusting, by the computing system, the historical route data based at least in part on the feedback.

15. One or more tangible non-transitory computer-readable media storing computer-readable instructions that when executed by one or more processors cause the one or more processors to perform operations, the operations comprising:
accessing route data comprising information associated with a starting location and a destination;
determining, based at least in part on the route data, one or more routes from the starting location to the destination;
determining, based at least in part on historical route data, one or more amounts of familiarity with one or more historical routes that were previously traveled by a user;
determining one or more similarities between the one or more routes and the one or more historical routes;
determining one or more suggested routes based at least in part on the one or more routes that satisfy one or more criteria associated with the one or more amounts of familiarity and the one or more similarities; and
generating output comprising one or more indications associated with the user traveling the one or more suggested routes.

16. The one or more tangible non-transitory computer-readable media of claim 15, wherein the output comprises one or more indications of when each of the one or more suggested routes was most recently traveled by the user.

17. The one or more tangible non-transitory computer-readable media of claim 15, wherein the one or more amounts of familiarity are positively correlated with a frequency of the user traveling the one or more historical routes or a recency of the user traveling the one or more historical routes.

18. A computing system comprising:
one or more processors;
one or more non-transitory computer-readable media storing instructions that when executed by the one or more processors cause the one or more processors to perform operations comprising:
accessing route data comprising information associated with a starting location and a destination;
determining, based at least in part on the route data, one or more routes from the starting location to the destination;
determining, based at least in part on historical route data, one or more amounts of familiarity with one or more historical routes that were previously traveled by a user;
determining one or more similarities between the one or more routes and the one or more historical routes;
determining one or more suggested routes based at least in part on the one or more routes that satisfy one or more criteria associated with the one or more amounts of familiarity and the one or more similarities; and
generating output comprising one or more indications associated with the user traveling the one or more suggested routes.

19. The computing system of claim 18, further comprising:
receiving an input from a user, wherein the input comprises a user selected route that is selected from the one or more suggested routes; and
generating one or more navigation directions from the starting location to the destination along the user selected route.

20. The computing system of claim 19, further comprising:
controlling operation of a vehicle based at least in part on the one or more navigation directions, wherein operation of the vehicle comprises navigating the vehicle from the starting location to the destination along the user selected route according to the one or more navigation directions.
